(19) United States
(12) Patent Application Publication
(10) Pub. No.: US 2019/0272375 A1
(43) Pub. Date: Sep. 5, 2019

(54) TRUST MODEL FOR MALWARE CLASSIFICATION

(71) Applicant: Intel Corporation, Santa Clara, CA (US)

(72) Inventor: Li Chen, Vancouver (CA)

(73) Assignee: Intel Corporation, Santa Clara, CA (US)

(21) Appl. No.: 16/367,611

(22) Filed: Mar. 28, 2019

(51) Int. Cl. G06F 21/56; G06N 3/08

(52) U.S. Cl. CPC G06F 21/562; G06F 21/563; G06F 2221/033; G06N 3/08

(57) ABSTRACT

There is disclosed in one example an apparatus, including: a hardware platform including a processor and a memory; an image classifier to operate on the hardware platform, the image classifier configured to classify an object under analysis as one of malware or benignware based on an image of the object; and a trust component configured to identify portions of the image that contribute to the classification.

### FIELD OF THE SPECIFICATION

This disclosure relates in general to the field of anti-malware technology, and more particularly, though not exclusively, to a system and method for providing a trust model for binary classification.

### BACKGROUND

Modern computers often have always-on Internet connections. Such connections can provide multiple vectors for security threats to attack a system.

### BRIEF DESCRIPTION OF THE DRAWINGS

The present disclosure is best understood from the following detailed description when read with the accompanying FIGURES. The patent or application file contains several drawings executed in color. Copies of this patent or patent application publication with color drawings will be provided by the Office upon request and payment of the necessary fee.

It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1a illustrates an overview of a system incorporated with the malware detection and classification technology of the present disclosure.

FIG. 1b illustrates a training system overview.

FIG. 2 illustrates an alternate system overview, depicting an “ensemble” system.

FIG. 3 illustrates the use of transfer learning.

FIGS. 4a-4l illustrate an example partially retrained deep neural network (DNN) classifier.

FIG. 5 illustrates an overview of the operational flow of a process for detecting and classifying malware.

FIG. 6 illustrates an overview of the operational flow of an alternate process for detecting and classifying malware, using an ensemble of two artificial neural networks.

FIG. 7 illustrates an overview of the operational flow of a process for training and validating a malware detection and classification system.

FIG. 8 illustrates a trust component analysis of a known malware object.

FIG. 9 illustrates a trust component analysis of a known benign object.

FIG. 10 is a block diagram of a deep transfer learning (DTL) model.

FIG. 11 is a block diagram of a model explainability and interpretability block, as added to a DTL model.

FIG. 12 is a block diagram of components in an explainability and interpretability block.

FIG. 13 illustrates a super-pixel representation.

FIGS. 14a-14e plot the top five labels and explanations by the DTL model for a static malware classification.

FIGS. 15a-15b illustrate a case where the model correctly predicts a malware object class with greater than 99% probability.

FIG. 16 is a block diagram of a home network.

FIG. 17 is a block diagram of a hardware platform.

FIG. 18 is a block diagram of components of a computing platform.

FIG. 19 is a block diagram of a central processing unit (CPU).

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

A principal concern in computer security is the identification of a new or unknown software application or code as being either malware or benignware. For purposes of this specification, malware can be broadly defined to include any object, including an executable file, that can harm, disrupt, or otherwise cause damage to a computer, a network, or the data owned by the person and/or enterprise operating a computer. One challenge in this space is that malware authors are becoming increasingly more sophisticated and are using techniques such as code obfuscation to defeat traditional anti-malware solutions that rely on checksums or hashes of known malware objects.

Artificial intelligence such as neural networks can be used to bridge the gap in detection that may arise when malware authors use obfuscation techniques. In one example, a malware object is submitted to analysis by a deep-learning artificial neural network (ANN). The deep-learning ANN can be used to recognize certain sequences of opcode n-grams that commonly occur in malware routines. This can be accomplished, in one example, by converting the object under analysis into a vector of 8-bit unsigned integers. This vector can then be converted into an appropriately-sized multi-dimensional array, such as a two-dimensional (2D) or three-dimensional (3D) array, that can be analyzed by a convolutional or non-convolutional neural network. In an embodiment, the neural network is one that has been pre-trained on natural image recognition. Certain layers, such as the first layers, are pre-trained for image recognition, and the subsequent layers are frozen. The partial network can then be retrained with on the malware images in order the fine-tune the deep neural networks. Because the neural network in this example is an image recognition or computer vision neural network, a 2D array may appear as a “picture” of the original 8-bit vector, or a 3D array could be considered to be an image with color channels. The computer vision model then “looks” at the “picture” of the object under analysis to determine if the object “looks” like malware. This is done by recognizing certain regions as having malware-like characteristics.

While this model has had some experimental success in identifying malware objects, its utility is limited if security analysts do not trust the model. Many existing ANNs of this type lack explainability and interpretability features that would increase a researcher's trust in the model. Rather, these models are “black boxes” that look at the image, determine whether it represents malware, and give a binary answer of either yes or no or which family of malware the image belongs to. Some classical machine learning models have been built that incorporate explainability and interpretability features, but the efficiency of those models is less compared with deep-learning-based malware classifiers.

Embodiments of the present specification provide a trust component to a deep learning-based malware classifier that does not harm the efficiency or capability of the deep learning model. The trust component in one example uses structure and texture information of a malware image to train the deep-learning model to predict malware. It then adds intelligence for the model to identify which portions of the image it predicts are contributing to the malware classification. This provides trustworthy explainability to the model.

This model provides substantial benefits in computer security. These benefits arise from the fact that machine learning is becoming increasingly important in computer and network security applications. Large volumes of both benignware and malware data are generated daily. This can require an automated algorithm that effectively detects malicious software with a low number of false positives identifying benignware. However, if security researchers, analysts, and practitioners do not trust the machine learning algorithm and its predictions, then despite the high classification accuracy or low false positive rate, it may not be deployed in the wild. The machine learning method disclosed herein uses an image representation of application binaries, such as EXE or ELF files, along with deep transfer learning (DTL) for efficient malware classification. In this approach, the application binary is directly mapped into integer values between 0 and 255 as a vector of 8-bit unsigned integers, and is then resized into a multi-dimensional array, such as a 2D array. A pre-trained deep-learning neural network such as a visual geometry group (VGG), Inception-BN, ResNet, or similar may be fine-tuned for the last few fully connected layers. This procedure is called deep transfer learning. The deep transfer learning model is trained on the malware represented as images. In a comparison analysis, the method disclosed achieves higher classification accuracy, lower false positive rate, higher true positive rate, higher F₁ score, and higher area under the curve, compared to selected classical machine learning methods.

While this method achieves superior performance compared to classical machine learning methods, and furthermore requires little manual feature engineering, the lack of interpretability, explainability, and trustworthiness can limit trust in the model. This is, in fact, a general issue in many machine learning applications and deployments. Particularly deep learning models are essentially black boxes with little explainability or intelligent interpretability. Thus, the present specification provides an explanation scheme as a trust component to enhance the trust of the image-based deep transfer learning algorithm for malware classification. This explanation scheme solves an optimization problem and helps to explain the prediction of deep learning-based malware classifiers. With this information, security practitioners can have better confidence in deploying and integrating the deep transfer learning model disclosed herein.

A system and method for providing a trust model for image-based malware classification will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

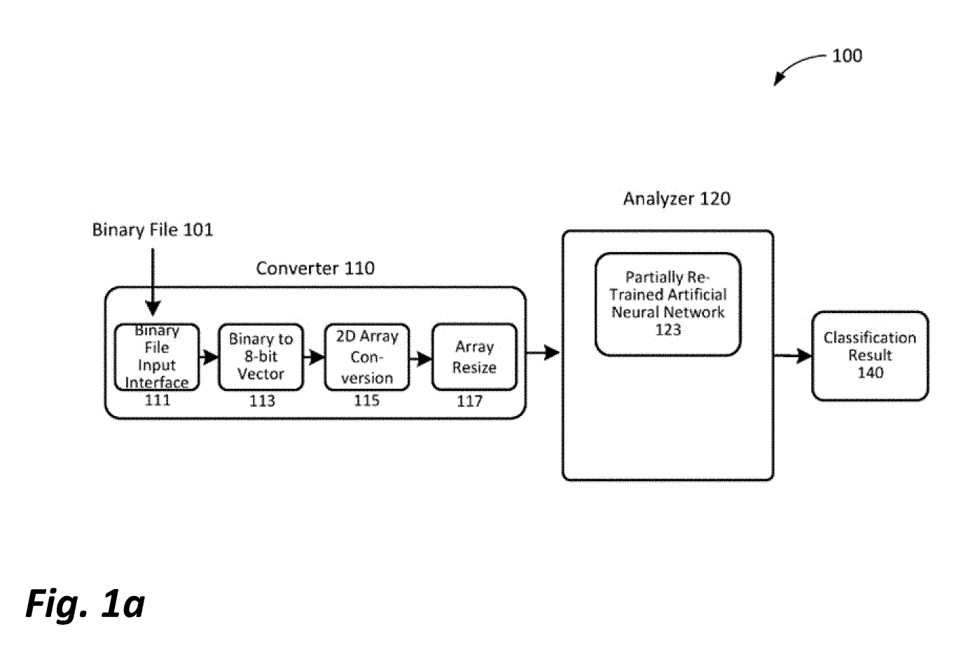

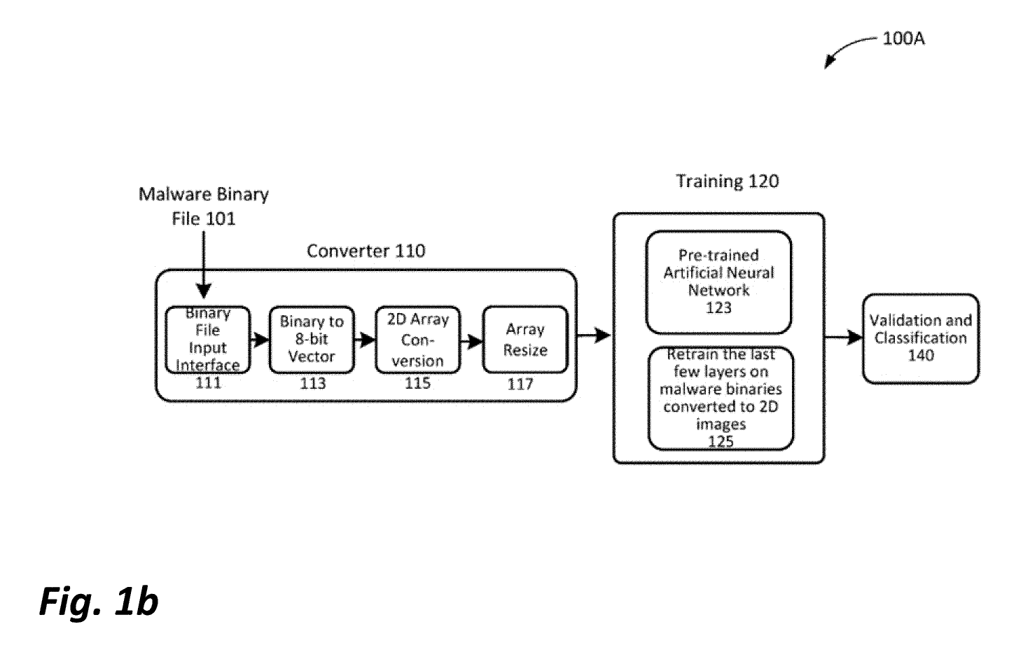

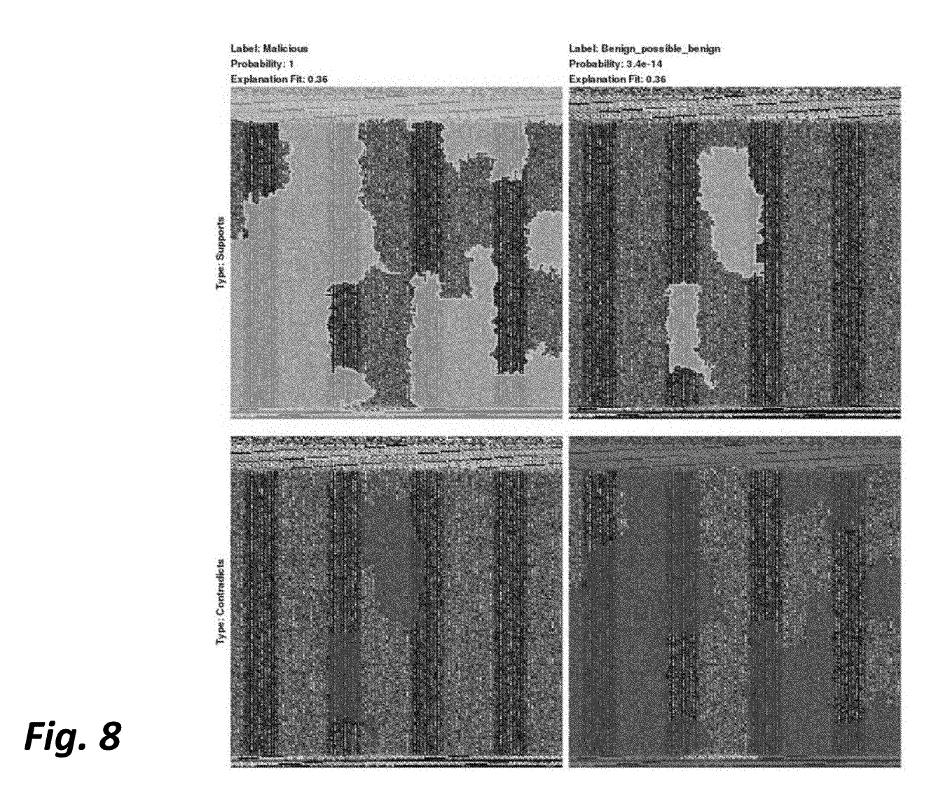

For clarity, the FIGURES disclosed herein may be usefully divided into three groups. FIGS. 1a-7 are focused primarily on the deep transfer learning model described herein that reduces a malware file to an image and uses computer vision models to determine whether the image “looks” like malware. FIGS. 8-15b are more focused on the trust component that identifies which portions of the image point toward the malware classification, and provide higher confidence in the prediction. The remaining FIGURES disclose hardware and software platforms that may be used in implementations and embodiments of the teachings disclosed herein. The division of those FIGURES into these three groupings should be understood as a convenience only, and as enhancing clarity and understanding. It should not be understood to be limiting, or to imply that a teaching disclosed in one portion is necessarily inapplicable or cannot be applied to the teachings of another portion.

FIG. 1a illustrates an overview of a system 100 incorporated with the malware detection and classification technology of the present disclosure.

For purposes of the present specification, an apparatus for computing may include a converter to receive and convert a binary file into a multi-dimensional array, the binary file to be executed on the apparatus or another apparatus, and an analyzer coupled to the converter to process the multi-dimensional array to detect and classify malware embedded within the multi-dimensional array. The converter may use at least one partially retrained artificial neural network having an input layer, an output layer and a plurality of hidden layers between the input and output layers. In embodiments, the converter may further output a classification result, where the classification result is used to prevent execution of the binary file on the apparatus or another apparatus.

By way of nonlimiting example, the multi-dimensional array may be a 2D array. In embodiments, the converter may first convert the binary file to a vector of 8-bit unsigned integers, and may then convert the vector to the 2D array. Further, in some embodiments, the converter may first convert the vector to an internal 2D array, and then resize the internal 2D array prior to the outputting the 2D array. In such embodiments, the resized 2D array may have a size of, for example, 224×224, or 299×299. In alternate embodiments, where the converter outputs two 2D arrays, to be respectively analyzed by two artificial neural networks, the resized arrays may have a first 2D array of, for example, 224×224, or 299×299, and a second 2D array of, for example, 28×28.

In some embodiments, the at least one partially retrained artificial neural network may include a neural network previously trained to recognize patterns, with the weights of a number of its initial layers frozen, and the weights of a number of its last layers retrained to recognize malware binaries. For example, the artificial neural network may include the Inception-BN network, with its last layer retrained to classify malware. Or, for example, in embodiments, the artificial neural network may be one of VGG 16 or VGG 19, with its top layers frozen and its last three layers retrained to classify malware.

In further embodiments, the apparatus may comprise a malware detector including the converter and the analyzer, or, for example, may include an operating system having the converter and the analyzer. In some embodiments, the apparatus may be a cloud server.

In the following description, a malware detection system that utilizes transfer learning is described. It is initially noted that ANNs may be quite expensive to train. For example, highly complex models may take weeks to train, using hundreds of machines, each equipped with expensive graphics processing units (GPUs). Thus, in embodiments, using transfer learning, an example apparatus may transfer as much knowledge as possible from a complex artificial neural network and apply that knowledge to a relatively smaller size dataset, such as, for example, malware binaries. As a result, as described below, in embodiments, a complex artificial neural network already trained on a large dataset may be partially trained on malware binaries in a short time. Furthermore, as also noted below, apparatus according to various embodiments are robust to code obfuscation.

In embodiments of the present specification, limited malware training data may be used to establish effective classification results. For example, a source setting may include textual information learned from 1.5 million images, which may then be applied to a target task of malware image classification. Thus, an ANN which was trained on the 1.5 million images need only be slightly retrained on a malware dataset to be able to accurately classify images as containing malware.

It is noted that various embodiments described herein may be said to transform a malware detection problem into a visual recognition problem. Thus, in embodiments, the effort and cost to extract malware features may be significantly reduced. It is also here noted that while conventional malware detection methods may require one or more of analyzing code, matching signatures, and counting histograms and loops, in embodiments, malware binaries converted to images may be quickly scanned and classified without requiring feature extraction or similar efforts. Thus, in accordance with various embodiments, visualization may be performed by an apparatus to examine the texture of malware binaries.

System 100 may include an apparatus including converter 110 and analyzer 120. Converter 110 and analyzer 120 may each be separate chips or modules, or for example, may be integrated into a single chip or module. With reference to FIG. 1a, a binary file 101 may be input to converter 110. The binary file may include audio data, textual data, image data, or the like. In general, binary file 101 is not known to be secure, and may contain malware, which is why it is desirable to scan it and classify it before allowing it to be executed on an apparatus, e.g., an apparatus having system 100 or any other apparatus that may be notified by system 100 of the classification result. If, after analysis, it is classified as being a type of malware, in embodiments, the classification result may be used to prevent execution of the binary file on an apparatus having system 100 or another apparatus that may be notified by system 100 of the classification result.

In embodiments, converter 110 may receive binary file 101 via binary file input interface 111, and may perform several pre-processing techniques. In embodiments, these techniques may include converting the binary file to a vector, such as, for example, a vector of 8-bit unsigned integers. In embodiments, this may be performed by binary to 8-bit vector conversion 113. Following conversion, the vector may be converted into a multi-dimensional array, such as, for example, a 2D array, as illustrated in the example apparatus of FIG. 1a, by 2D array conversion 115. For example, the 1D 8-bit vector may be converted into a 2D array whose size depends upon the length of the 1D vector. For example, 2D array conversion may set a width and height of the 2D array according to the following table, where the height of the 2D array is the total length divided by the width:

TABLE 1
2D Array Width/Height

| Length (bytes) | Width | Height |
|---|---|---|
| <=1000 | 512 | Length/512 |
| >1000 to 1500 | 1024 | Length/1024 |
| >1500 | 2048 | Length/2048 |

In embodiments, the 2D array generated by 2D array conversion 115, may be further resized to accommodate an input size required by an ANN to be used to process it. Thus, for example, considering some well-known convolutional artificial neural networks, VGG16, VGG19, Inception-BN, AlexNet and ResNet all accept 224×224 input images, while Inception v3 and Xception require 299×299 pixel inputs. On the other hand, LeNet has an input size of 28×28. Thus, in embodiments, the last module shown in converter 110, i.e., array resize 117, may resize the 2D array created by 2D array conversion 115 to one or more resized 2D arrays. Because a 2D array of data, especially a 2D array including 8-bit unsigned integers, may be thought of as an image, where each element describes a greyscale value between 0 and 255, such a 2D array may be referred to herein as “a 2D image.”

It is here reiterated that a 2D array is only one example of a multi-dimensional array that may be used in various embodiments, and is thus nonlimiting. It is thus understood that for other multi-dimensional arrays, in embodiments, each of array conversion 115 and array resize 117 modules of converter 110 as shown in FIG. 1a may generate and resize arrays of various dimensions.

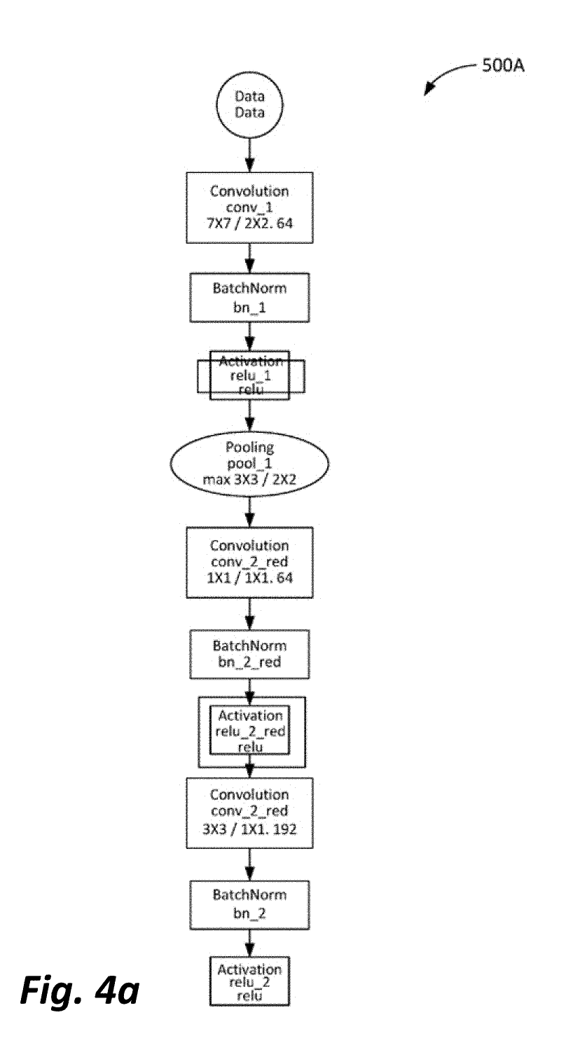

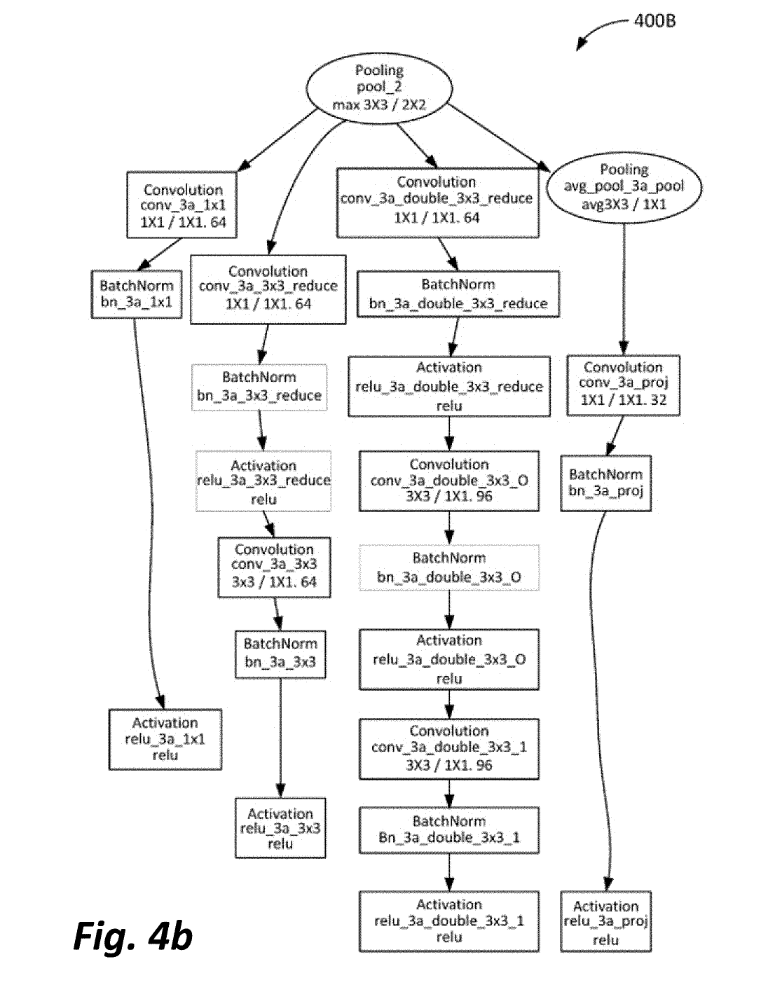

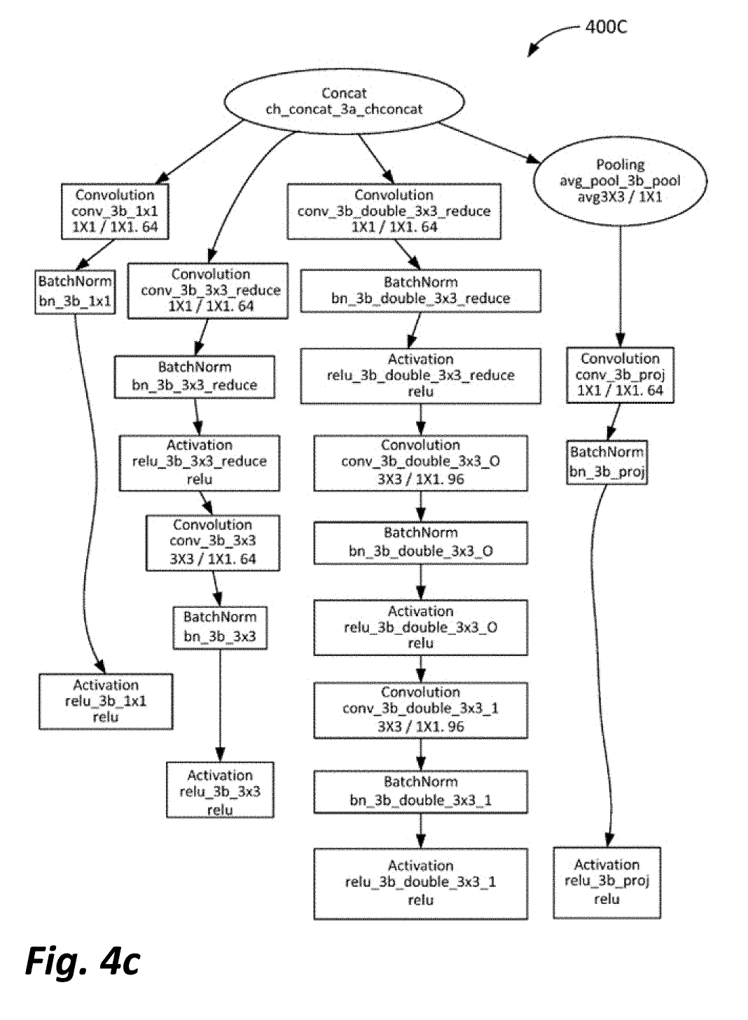

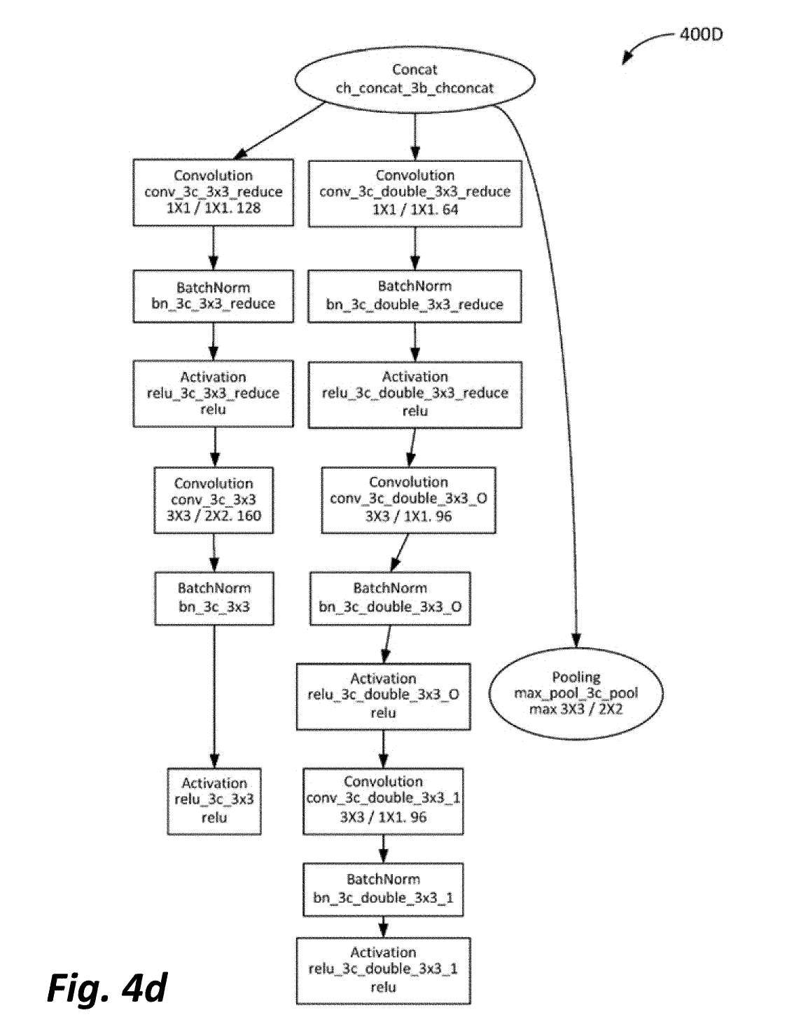

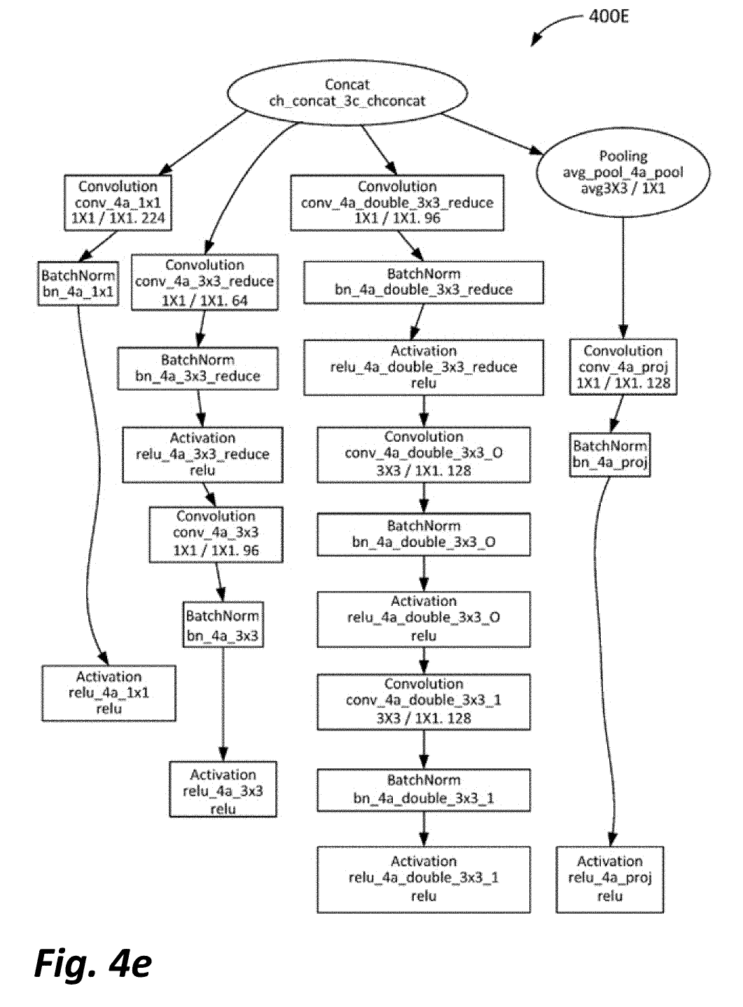

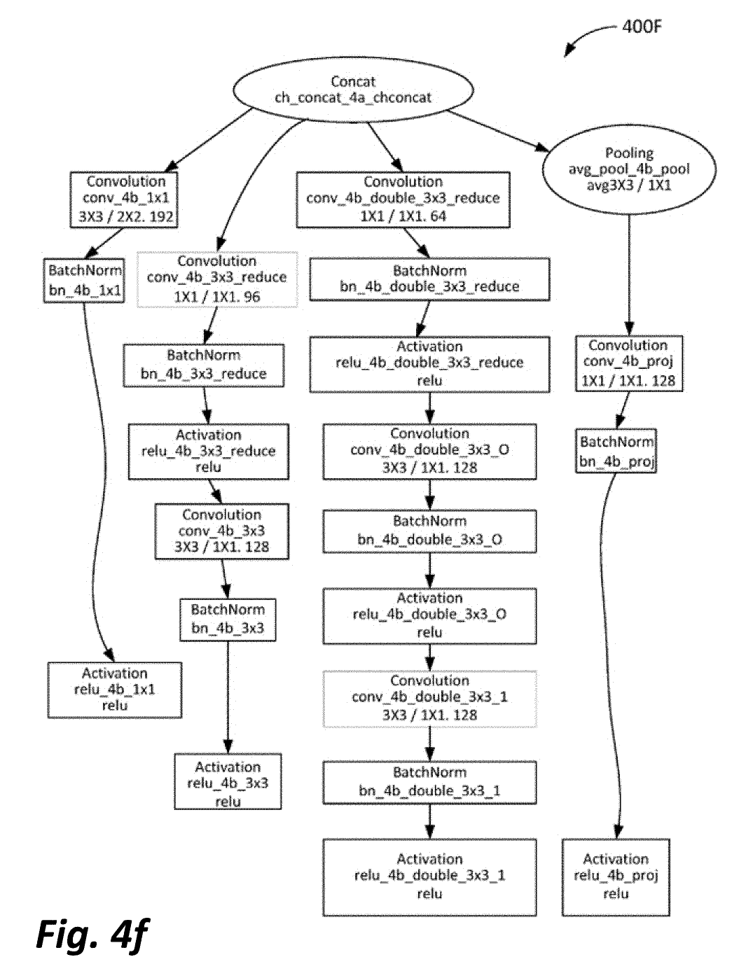

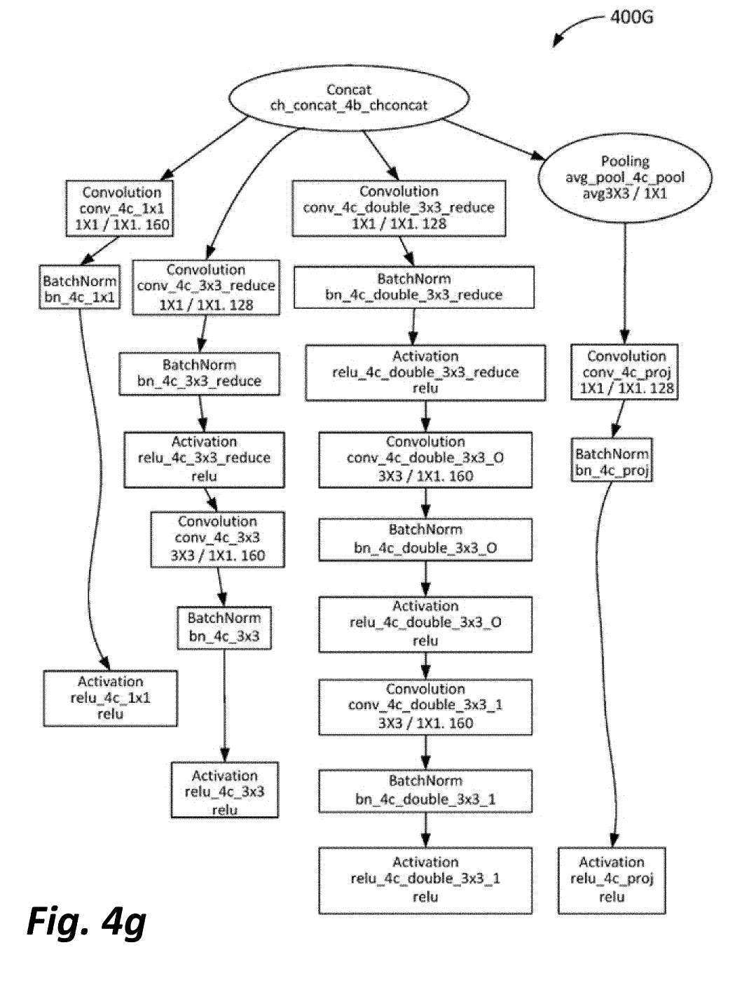

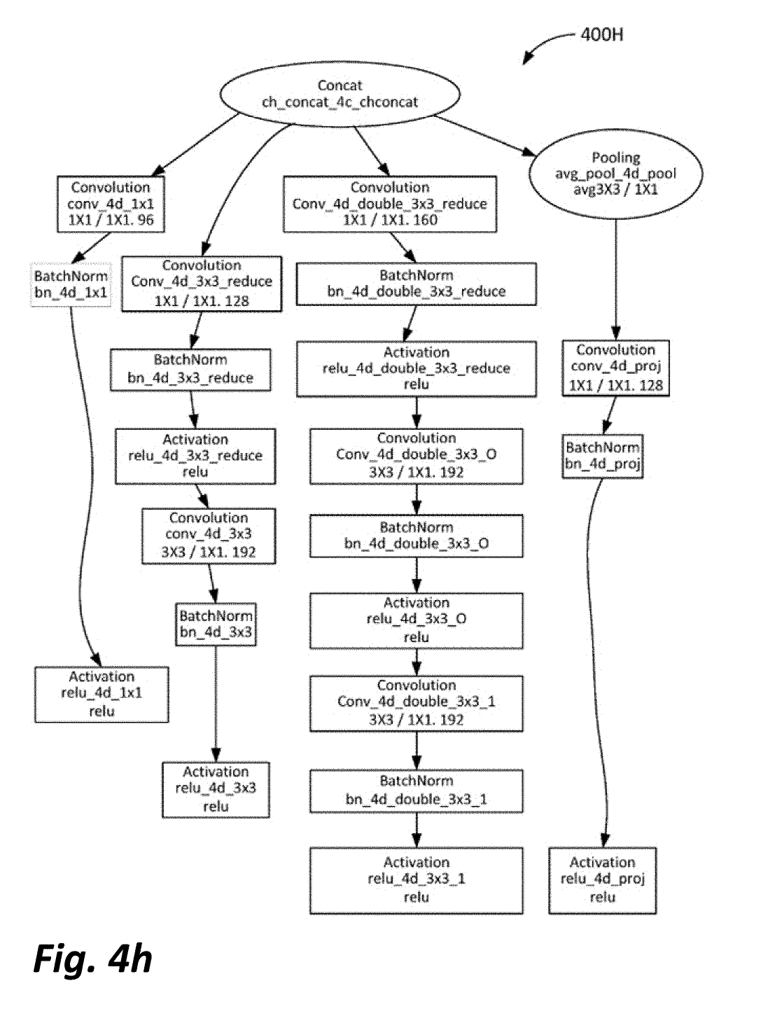

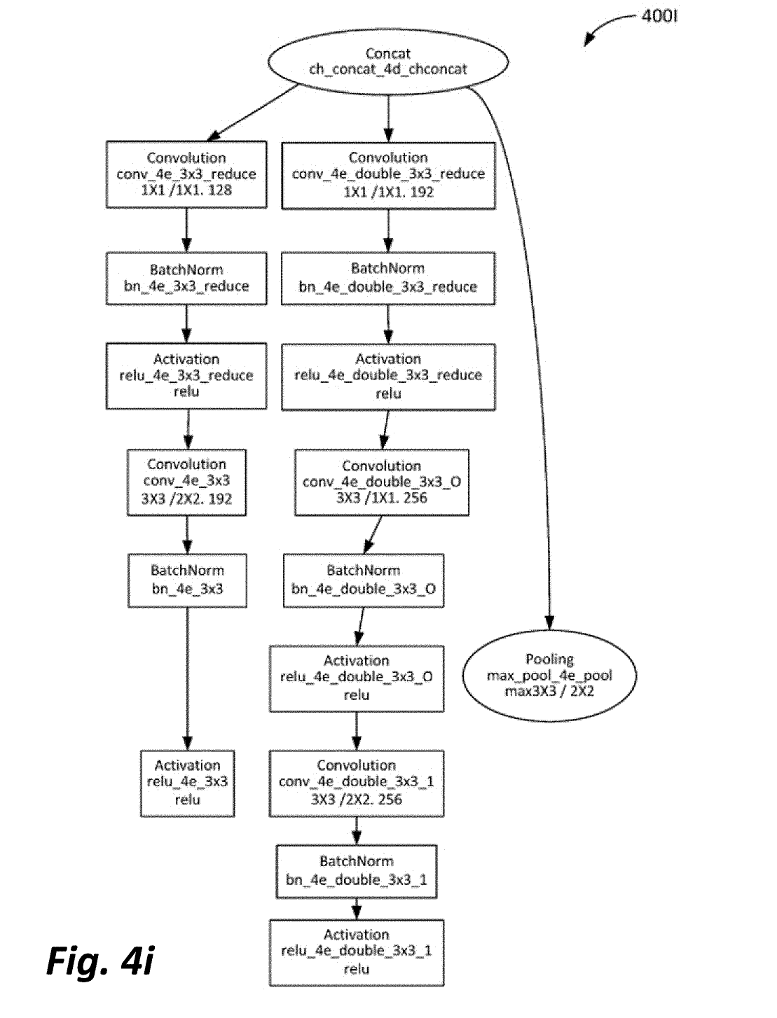

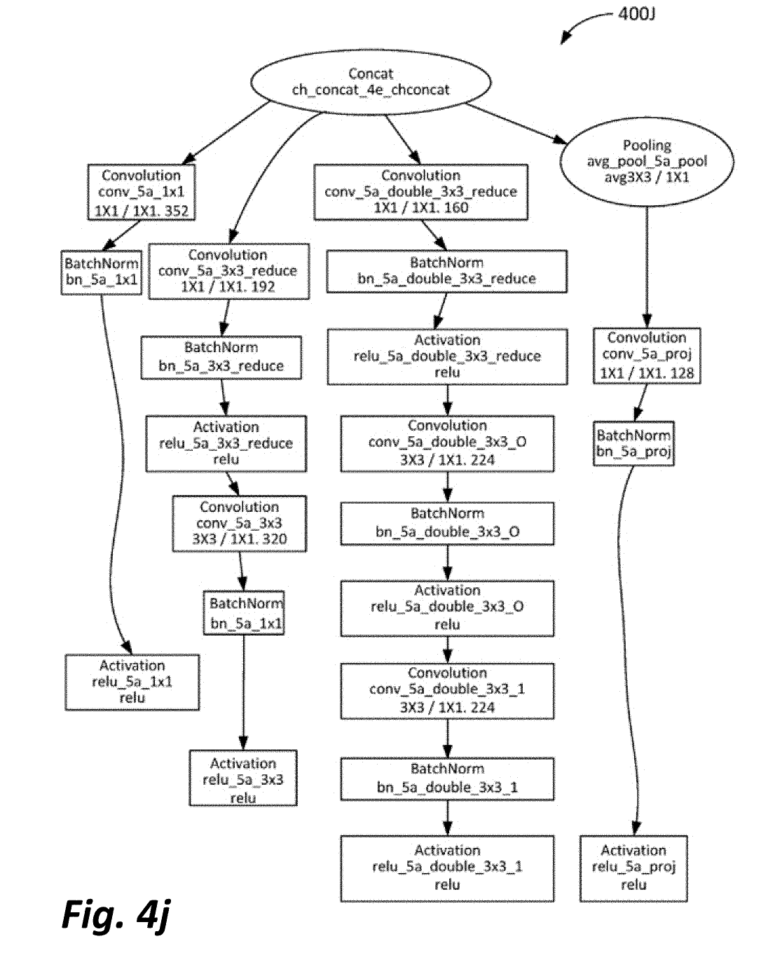

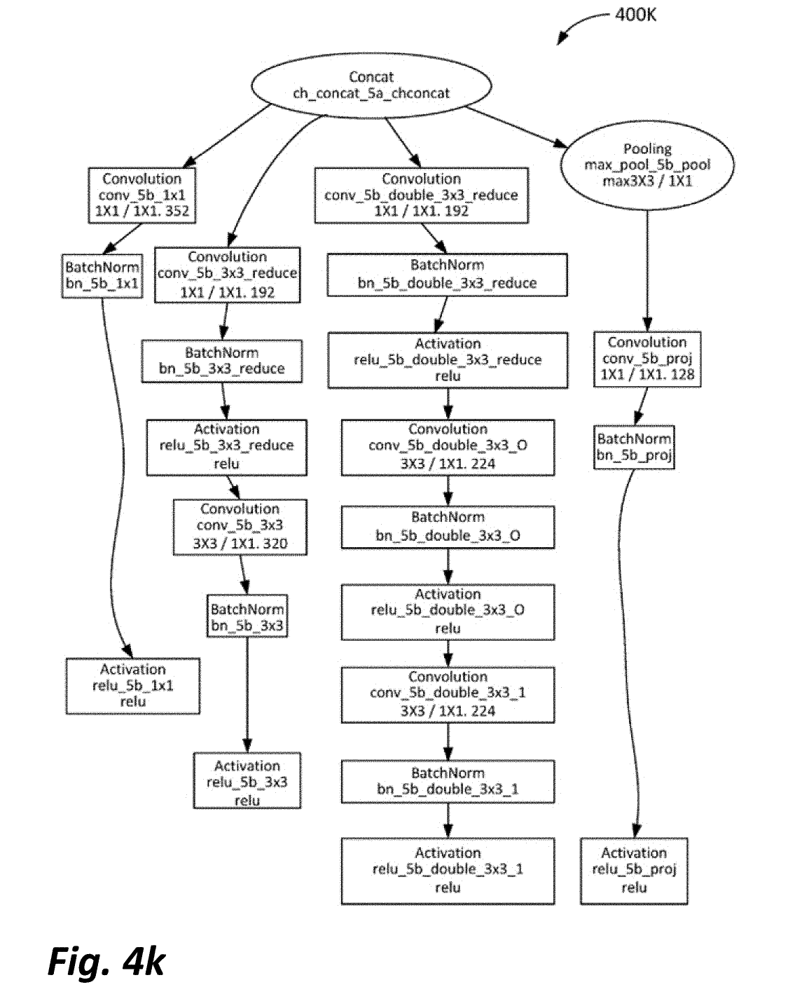

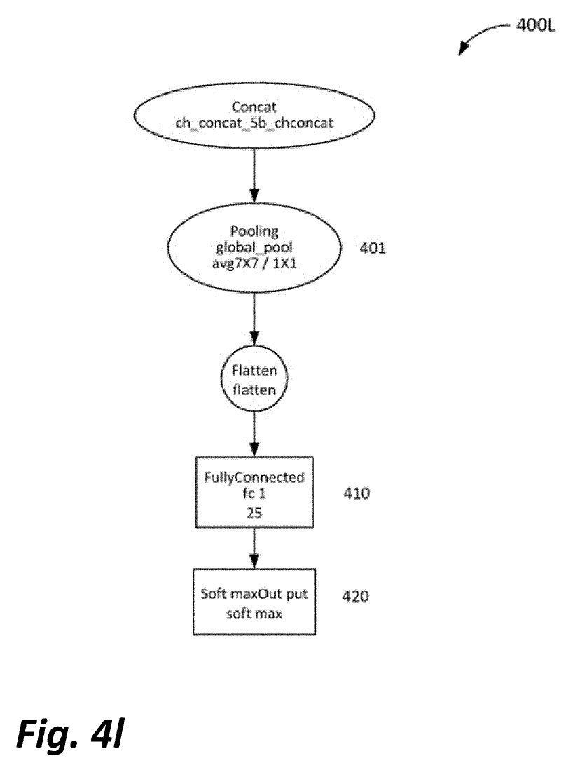

Continuing with reference to FIG. 1a, in embodiments, a resized 2D array output from array resize 117 may be input to analyzer 120. Analyzer 120 may include a partially retrained ANN 123 having an input layer, an output layer and a plurality of hidden layers between the input and output layers, for example, a convolutional neural network such as Inception-BN. An example partially retrained version of Inception-BN is illustrated in FIGS. 4a through 4l, described below. It is here noted that ANN 123 may be referred to as a deep neural network, and further, leveraging transfer learning, as described above, may be utilized in accordance with various embodiments. Thus, in embodiments, the first several layers of an ANN may be frozen, and its weights obtained from existing state-of-the-art neural network models. In embodiments, this information may be obtained from domains such as, for example, natural image classification or computer vision. Then, the rest of the layers of the ANN, i.e., those not frozen, may be tuned and trained on domain-specific data, such as, in accordance with various embodiments, malware images, obtaining a partially retrained ANN 123. This retraining process is described more fully below, with reference to FIG. 1b.

Finally, after processing the resized 2D array with partially retrained ANN 123, a classification result 140 may be obtained. In embodiments, if classification result 140 is a type of malware, then classification result 140 may be used to prevent execution of binary file 101 on an apparatus having system 100 or another apparatus that may be notified by system 100 of the classification result.

In embodiments, system 100 may be implemented as a malware detector having converter 110 and analyzer 120. Alternatively, system 100 may comprise an operating system having converter 110 and analyzer 120. Still alternatively, system 100 may be a cloud server.

FIG. 1b illustrates an overview of a training system 100A. In embodiments, training system 100A may be very similar to system 100 of FIG. 1a, with a few variations. For ease of description, only these variations will be described. In embodiments, training system 100A may be used to train the ANN of system 100 of FIG. 1a, namely partially retrained ANN 123. In embodiments, training system 100A may include the same converter 110, with the same components, as does system 100 of FIG. 1a. It is noted, however, that malware binary file(s) 101 that are input into training system 100A may be a training set of malware binary files known to contain specific types of malware, which may be used to train the final layers of ANN 123, using retraining module 125.

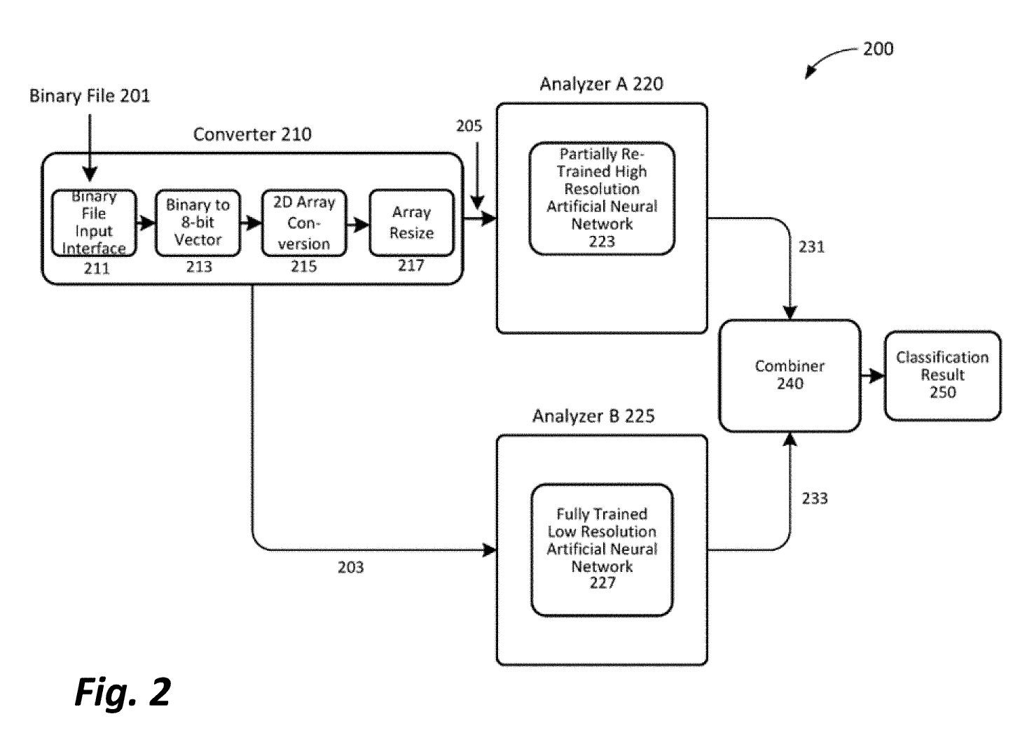

Thus, training system 100A of FIG. 1b, instead of using a fully trained analyzer to process 2D images, may instead include training module 120. Training module 120, as shown, may load a pre-trained ANN 123, that may be partially retrained by retraining module 125. As shown, in embodiments, retraining module 125 may retrain the last few layers of pre-trained ANN 123 using a set of malware containing binaries converted to 2D images, where the malware containing binaries are input to converter 110, as shown. In other embodiments, training system 100A may be used to fully train all layers of an ANN, such as, for example, low resolution model 205 as shown in FIG. 2, described below.

It is noted that when the 2D images are resized by array resize module 117 to 224×224, for example, there are several ANNs that may be utilized as pre-trained ANN 123, and thereby leverage transfer learning in accordance with various embodiments. These ANNs may include, for example, Inception-BN, VGG, or AlexNet, as noted above. In embodiments, the architecture may be kept as the original model, and then the last pooling layer, prior to all of the fully connected layers, toward the end of the neural network architecture, may be identified. Then the parameters and weights prior to the last pooling layer may be kept the same. In embodiments, the parameter names of the last few fully connected layers may be kept the same, but the values may be updated based on training on a specific malware dataset. In embodiments, the training dataset may be partitioned into a training set and a validation set.

Continuing with reference to FIG. 1b, once the last few layers of the pre-trained ANN 123 have been retrained, it remains to decide which epoch of the ANN to select. This is the function of validation and classification module 140.

In embodiments, the parameters of the ANN may be initialized as uniform distribution or Gaussian distribution. Next the learning rates, number of epochs, evaluation metric, momentum, weight decay, stochastic gradient descent as the optimizer and batch size may be set. Then, in embodiments, the model at a k^{th} epoch may be set as a final model, based on the validation accuracy. It is noted that if the training accuracy increases while the validation accuracy decreases, this will cause overfitting. However, if the training accuracy and validation accuracy are both increasing, this indicates that the model has not yet converged, and may still be trained for better accuracy. In embodiments, when an epoch is reached in which the validation accuracy of the model does not increase, but the validation accuracy has not yet begun to decrease, the model at the corresponding k^{th} epoch may be selected. This model may then be used for testing, for example as partially retrained ANN 123, of analyzer 120, in FIG. 1a.

An example partially retrained ANN is depicted in FIGS. 4a through 4l. Here a pre-trained ImageNet Inception-BN network was used to store initial weights. These are depicted in FIGS. 4a through 4k. The final layer was then retrained, the output of which is shown in FIG. 4l. Thus, in the example Inception-BN network of FIGS. 4a through 4l, the Inception-BN network was loaded at the 126th iteration, and the weights and architecture for the earlier weights frozen. It is noted that these weights were obtained from training the Inception-BN ANN on the 10 million images from the ImageNet dataset. Then the last fully connected layer and softmax layer, i.e., fully connected layer 410 and softmax layer 420 of FIG. 4l, were retrained on a training set of malware images. In this example, the last layers were retrained using a benchmark dataset containing 9,458 types of malware from 25 malware families. These families include, for example, Adialer, Agent, Allaple, and Yuner.

In an alternate example, if a VGG network is chosen as pre-trained ANN 123, then system 100A may freeze the top layers and retrain module 125 may retrain, after max-pooling, the last three fully connected layers and a softmax layer.

FIG. 2 illustrates an alternate system overview, depicting an “ensemble” system 200. It is noted that the example system of FIG. 2 is a superset of that of system 100 of FIG. 1a. Converter 210 of FIG. 2 is equivalent to converter 110 of FIG. 1a, and analyzer A 220 of FIG. 2 is equivalent to analyzer 120 of FIG. 1a. Similarly, classification result 250 of FIG. 2 is equivalent to classification result 140 of FIG. 1a. As a result, these equivalent elements of system 200 need not be further described.

Continuing with reference to FIG. 2, the additional elements of system 200, not having equivalents in FIG. 1a, include analyzer B 225, and ensemble module 240. System 200 of FIG. 2 thus uses two analyzers, analyzer A 220, which includes a partially retrained ANN 223, equivalent to partially retrained ANN 123 of FIG. 1a, and a second analyzer, analyzer B 225, which includes a fully trained low resolution ANN 225, which, in embodiments, may be a lower resolution model with a top-to-bottom training scheme on malware binaries. It is here noted that, in embodiments, low resolution ANN 227 may be trained from scratch to recognize malware binaries, or, in alternate embodiments, it may be an ANN that is trained from scratch to recognize malware binaries, but whose architecture may be preserved from existing neural network architectures, such as, for example, a LeNet structure, a CIFAR-10 neural network structure, or, for example, multilayer perceptrons to allow training and testing on different sizes of lower resolution malware images.

In embodiments, because ANN 227 is a lower resolution model, it may accept as inputs smaller 2D images. Thus, in embodiments, converter 210 may output two versions of a resized 2D image, one input to analyzer A through link 205, and the other input to analyzer B through link 203. In embodiments, the resized 2D image input to analyzer B 225 may have, for example, a size in the range from 28 by 28 to 64 by 64. In embodiments, fully trained low resolution ANN 227 may include, for example, a LeNet structure, a CIFAR-10 neural network structure, or, for example, multilayer perceptrons to allow training and testing on different sizes of lower resolution malware images.

In embodiments, each of analyzers A and B, respectively containing high resolution partially retrained ANN 223 and fully trained low resolution ANN 227, may process their respective versions of resized 2D images received from converter 210. These results may then each be input to combiner 240, via links 231 and 233. In embodiments, combiner 240 may produce as output a classification result 250. In embodiments, classification result 250 may provide a probability of whether binary file 201 is, or contains, a malicious application or a benign application. In embodiments, if the result is malicious, combiner 240 may further provide a probability as to which malware family the application belongs to. In embodiments, in generating classification result 250, combiner 240 may ensemble (i.e., combine) the results of each of analyzers A and B.

In embodiments, combiner 240 may have several modes of combining results. For example, it may take a weighted average, average, majority vote, weighted majority vote, or boosting on the models, to combine the results of each of analyzers A and B. It is here noted that boosting is an iterative procedure, which may contain multiple classifiers. The training set used for each of the classifiers may be chosen based on the performance of each classifier. Boosting chooses misclassified training data points more frequently than correctly classified training data. In embodiments, combiner 240 may generally give higher weight to the output of the high resolution model, i.e., ANN 223. It is here noted that in experiments performed using various embodiments, it was observed that the two ANNs 223 and 227 disagreed less than 2% of the time. In embodiments, such disagreement may include whether malware is present in the binary file at all, or, given that malware is present, which type of malware it is. Thus, for example, if ANN 223 achieves a 99% accuracy and ANN 227 achieves a 97% accuracy, in embodiments, there is still room to achieve a higher than 99% accuracy by ensembling the two ANNs. Moreover, if one ANN predicts that an input file is malicious with a 85% probability, and the other ANN predicts that the file is malicious with a 55% probability, in embodiments, using an ensemble may strengthen the probabilities and confidence of prediction.

It is here noted that when the high resolution ANN disagrees with the low resolution ANN and the high resolution one correctly predicts, it may be that the low resolution ANN does not contain as much information as possible as the high resolution ANN. On the other hand, when the two disagree but the low resolution ANN correctly predicts, it may be that the low resolution ANN, due to the training of all of its layers, i.e., from top to bottom, only on malware data (rather than using the transfer learning scheme of ANN 223), may capture and extracts features of the malware dataset more accurately.

In embodiments, higher resolution ANN 223 may be considered to have greater accuracy. Therefore, in embodiments, in the combiner's ensemble process, the higher resolution model may preferably be accorded greater weight. However, in embodiments, lower resolution ANN 227 may also be very useful, as it may help improve overall accuracy of classification result 250. Because, in embodiments, lower resolution ANN 227 is trained on malware data from top to bottom layers, without utilizing other learned knowledge from a different domain, in embodiments, feature extraction by low resolution ANN 227 may help differentiate cases where features of the binary file extracted by high resolution ANN 223 cannot be distinguished.

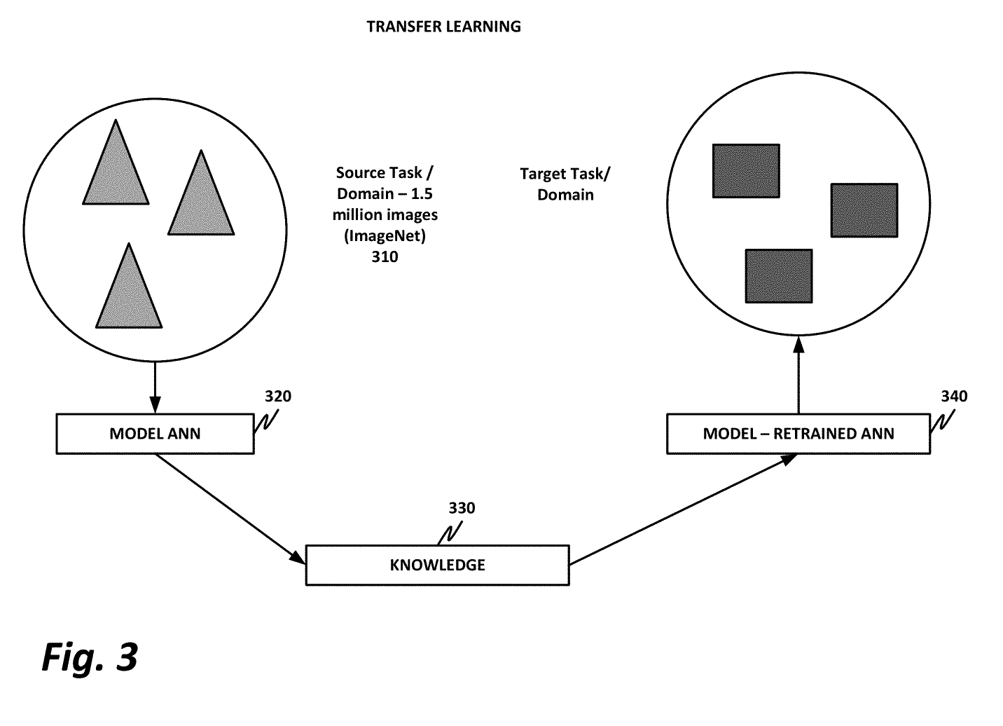

FIG. 3 illustrates the use of transfer learning. Transfer learning involves storing knowledge gained solving one problem and applying it to a different but related problem. It is here noted generally that transfer learning involves the concepts of a domain and a task.

More rigorously, a domain D may consist of a feature space X and a marginal probability distribution P(X) over the feature space, where X=xl, . . . xn. Given a domain, D−[X, P(X)], a task T may consist of a label space Y and a conditional probability distribution P(Y|X) that is typically learned from the training data consisting of pairs xi∈X and yi∈Y. In embodiments, Y may be the set of all malware family labels.

Given a source domain D_{S}, a corresponding source task T_{S}, as well as a target domain D_{T} and a target task T_{T}, the objective of transfer learning now is to enable us to learn the target conditional probability distribution P(Y_{T}|X_{T}) in with the information gained from T_{S} where D_{S}≠D_{T} or T_{S}≠T_{T}.

FIG. 3 illustrates the application of these principles to the use of transfer learning in malware detection and classification systems, in accordance with various embodiments. Thus, with reference to FIG. 3, a source domain D_{Z} 310 may include 1.5 million images. An ANN 320, such as, for example, Inception-BN, may be trained on source domain 310 for the source task T_{T} of image feature extraction and classification. As a result, it contains knowledge 330 that may be ported to a target domain D_{T} of benchmark malware dataset 350 and a target task T_{T} of malware feature extraction and detection in malware binaries converted to resized multi-dimensional arrays. As shown, this may be accomplished by retraining ANN 320 on target domain D_{T} 350, to obtain retrained ANN 340. In embodiments, one benefit of using transfer learning is the sheer difference in size of the source and target domains. There is generally a limited number of target domain examples, the malware binaries. This number is exponentially smaller than the number of labeled source examples that are available, namely the images in the ImageNet database.

FIGS. 4a-4l illustrate an example partially retrained deep neural network (DNN) classifier. In embodiments of the present disclosure, the Inception-BN network was first trained on the 1.5 million images in ImageNet. Subsequently, using the training system illustrated in FIG. 1b, the last two layers of Inception-BN network was retrained using, as noted above, a benchmark malware dataset. As noted above, FIGS. 4a through 4k depict the frozen layers of the example Inception-BN network, and FIG. 4l depicts the retrained last two layers (below, or following, final pooling layer 401), fully connected fc 1 410 and softmax 420.

In this example, because the pre-trained ANN included 3-channels while the malware training data was one-channel, the resized 2D greyscale images were duplicated twice to convert to three channels of input data.

It is noted that to initialize the retraining of an Inception ANN, first the parameters initially in the layer in FIG. 4L may be uniformly sampled. Then a learning rate, momentum and number of epochs may be set to proceed with the retraining. In the training of the ANN of FIGS. 4a through 4l, the model training scheme converged at the 10th epoch. The following is exemplary pseudocode that may be used, in embodiments, to program such retraining:
load the pre-trained Inception-BN at 126th iteration;
freeze the weights and architecture for earlier weights as seen in FIGS. 4a-4k;
reassign fully connected weight and fully connected bias parameters. Initiate parameter
values by randomly sample from uniform distribution; retrain the network on the fully connected layer;
use validation dataset to determine the model to use, (i.e. model at which epoch).

As noted above, if it is desired to use a VGG ANN for transfer learning, then, in embodiments, a system may freeze the top layers of the VGG ANN and then retrain its last three layers for malware classification.

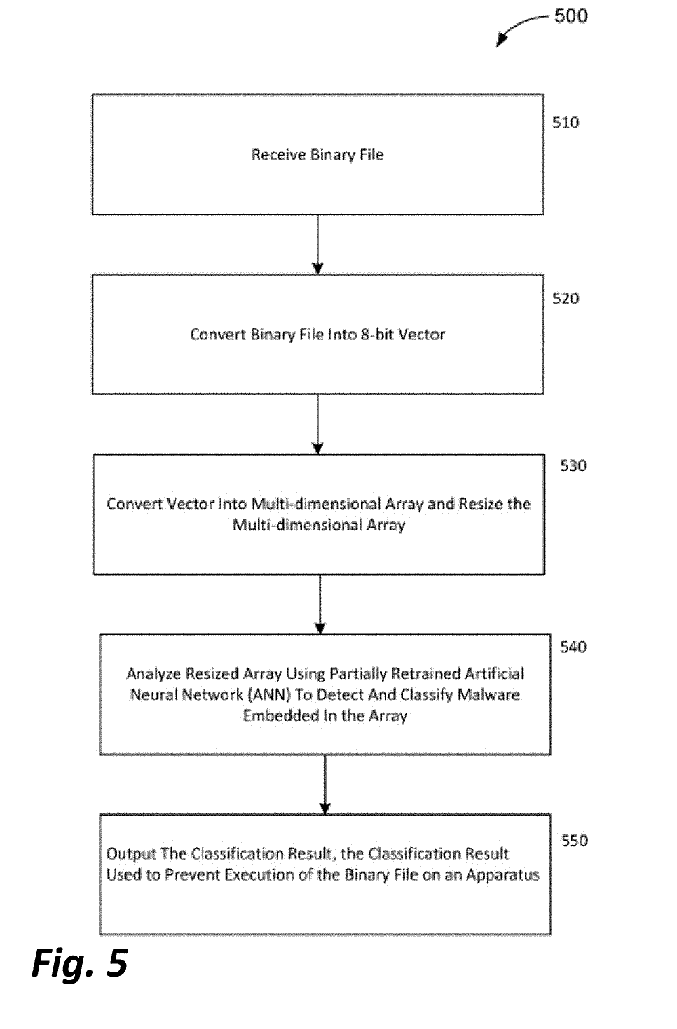

FIG. 5 illustrates an overview of the operational flow of a process for detecting and classifying malware. With reference to FIG. 5, process 500 may be performed by a system or apparatus according to various embodiments. In embodiments, process 500 may be performed by a system similar to that shown in FIG. 1a. Process 500 may include blocks 510 through 550. In alternate embodiments, process 500 may have more or fewer operations, and some of the operations may be performed in different order.

Process 500 may begin at block 510, where an example system may receive a binary file. The binary file may comprise audio data, textual data, image data, or the like. In general, the binary file is not known to be secure, and may contain malware, which is why it is desirable to scan and classify it before allowing it to be executed any apparatus. From block 510 process 500 may proceed to block 520, where the binary file may be converted into an 8-bit vector. In embodiments, the vector may be of 8-bit unsigned integers. More generally, in embodiments, the vector may map the binary representation of a file to integers between 0 and 255.

From block 520 process 500 may proceed to block 530, where the 8-bit vector may be converted into a multi-dimensional array, and then resized. In embodiments, the multi-dimensional array may be a 2D array, and may be resized to a size of 224 by 224, or 299 by 299, for example. In embodiments, blocks 510 through 530 may be performed by converter 110 depicted in FIG. 1, for example.

From block 530 process 500 may proceed to block 540, where the resized multi-dimensional array may be analyzed using a partially retrained ANN to detect and classify malware embedded in the array. In embodiments, the multi-dimensional array may be a 2D array, and may be resized to a size of 224×224, or 299×299, for example. In embodiments, the partially retrained ANN may have an input layer, an output layer and a plurality of hidden layers between the input and output layers. In embodiments, block 540 of process 500 may be performed by analyzer 120 depicted in FIG. 1, for example. Finally, from block 540 process 500 may proceed to block 550, where, a classification result may be output, which may be used to prevent execution of the binary file on an apparatus. At block 550, process 500 may terminate.

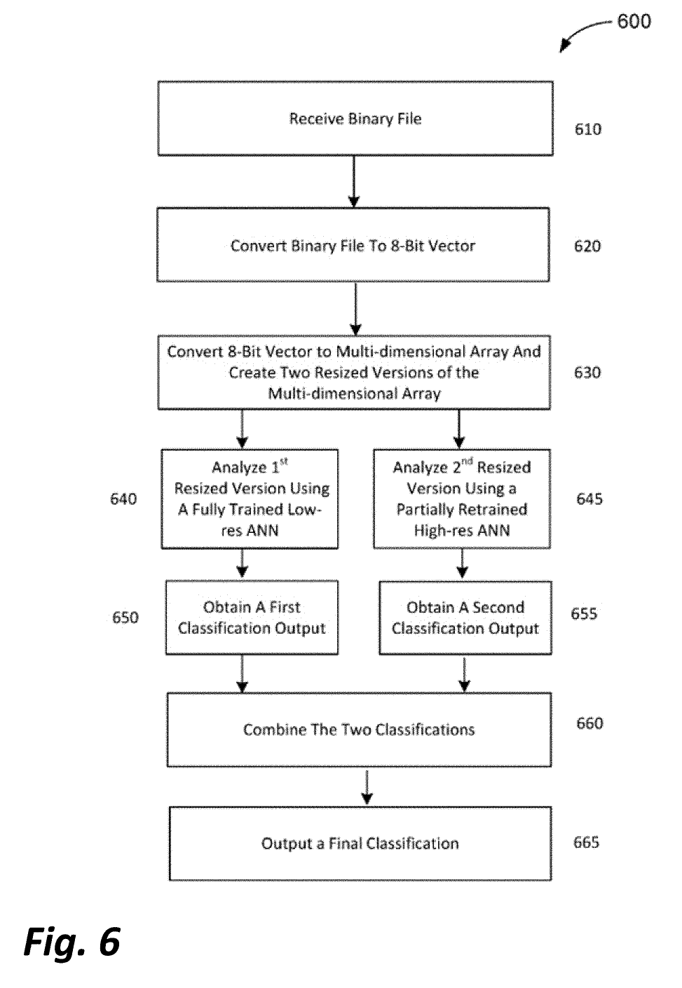

FIG. 6 illustrates an overview of the operational flow of an alternate process 600 for detecting and classifying malware, using an ensemble of two artificial neural networks. With reference to FIG. 6, process 600 may be performed by a system or apparatus, according to various embodiments. In embodiments, process 600 may be performed by a system similar to that shown in FIG. 2. Process 600 may include blocks 610 through 665. In alternate embodiments, process 600 may have more or fewer operations, and some of the operations may be performed in different order.

Process 600 may begin at block 610, where an example system may receive a binary file. The binary file may comprise audio data, textual data, image data, or the like. In general, the binary file is not known to be secure, and may contain malware, which is why it is desirable to scan and classify it before allowing it to be executed any apparatus. From block 610 process 600 may proceed to block 620, where the binary file may be converted into an 8-bit vector. In embodiments, the vector may be of 8-bit unsigned integers. More generally, in embodiments, the vector may map the binary representation of a file to integers between 0 and 255.

From block 620 process 600 may proceed to block 630, where the 8-bit vector may be converted into a multi-dimensional array, and then the multi-dimensional array resized into two versions, of different sizes, to use as respective inputs into two separate ANNs. In embodiments, a first version of the resized array may be smaller, for input into a lower resolution ANN, and a second version of the resized array may be larger, for input into a higher resolution ANN. In embodiments, the multi-dimensional array may be a 2D array, and a first resized version of the 2D array may have a size of 224×224, or 299×299, for example. In embodiments, a second resized version of the 2D array may have a size of between 28×28 and 64×64, for example. In embodiments, blocks 610 through 630 may be performed by converter 210 as depicted in FIG. 2, for example.

From block 630 process 600 may bifurcate, and may proceed to both block 640 and block 645. At block 640, a first resized version of the multi-dimensional array, i.e., the smaller version, may be analyzed using a fully trained low resolution ANN to detect and classify malware embedded in the array. Similarly, and in parallel, at block 645, a second resized version of the multi-dimensional array, i.e., the larger version, may be analyzed using a partially retrained high resolution ANN to detect and classify malware embedded in the array. In embodiments, the partially retrained ANN may have an input layer, an output layer, and a plurality of hidden layers between the input and output layers.

From blocks 640 and 645, process 600 may proceed, respectively, to blocks 650 and 655. At block 650 a first classification output of the binary file may be obtained, from the low resolution ANN, and at block 655 a second classification output of the binary file may be obtained, from the high resolution ANN. In embodiments, blocks 640 and 650 of process 600 may be performed by analyzer B 225 depicted in FIG. 2, for example, and blocks 645 and 655 of process 600 may be performed by analyzer A 223 depicted in FIG. 2, for example. Finally, from blocks 650 and 655, process 600 may converge, and proceed to block 660, where the two classification outputs may be combined. In embodiments, block 660 may be performed by combiner 240 depicted in FIG. 2. In embodiments, the two classification outputs may be combined using various algorithms, such as, for example, weighted average, average, majority vote, weighted majority vote, or boosting on the ANNs.

Finally, from block 660, process 600 may proceed to block 665, where a final classification may be output, which may be used to prevent execution of the binary file on an apparatus. At block 665, process 600 may terminate.

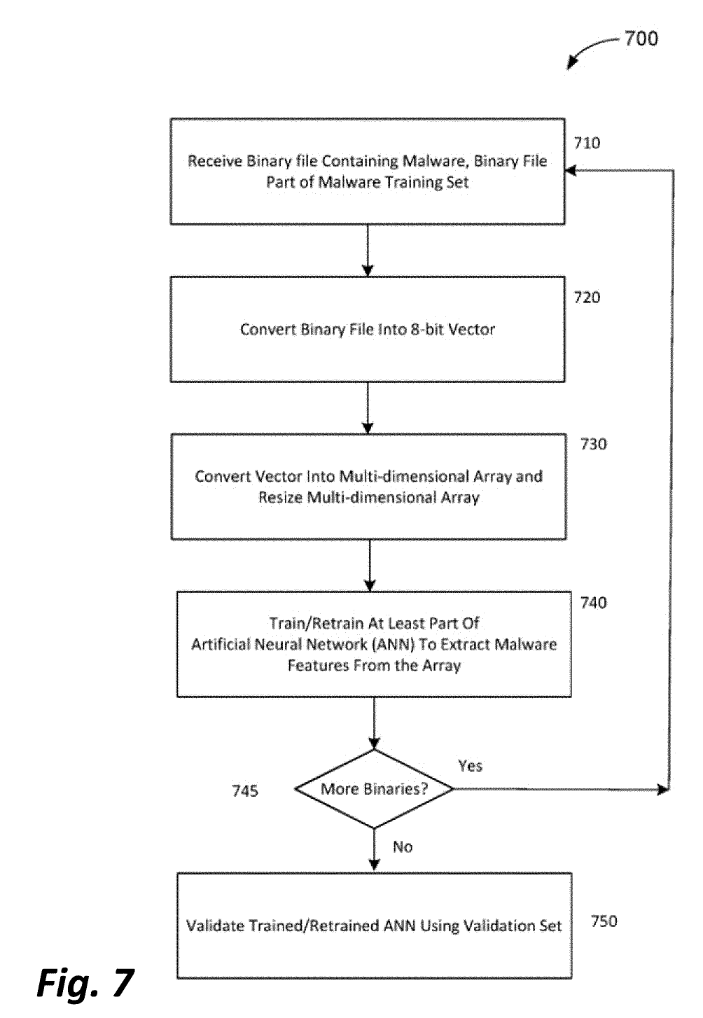

FIG. 7 illustrates an overview of the operational flow of a process 700 for training and validating a malware detection and classification system. It is noted that just as system 100 of FIG. 1a is similar to system 100A of FIG. 1b, process 700 is similar to process 500 of FIG. 5, with some variation for the specifics of training.

With reference to FIG. 7, process 700 may be performed by a system or apparatus according to various embodiments. In embodiments, process 700 may be performed by a system similar to that shown in FIG. 1a. Process 700 may include blocks 710 through 750. In alternate embodiments, process 700 may have more or fewer operations, and some of the operations may be performed in different order.

Process 700 may begin at block 710, where an example system may receive a binary file. The binary file may comprise audio data, textual data, image data, or the like. The binary file may contain malware, as part of a malware binary training set that may be used to train an ANN on. From block 710 process 700 may proceed to block 720, where the binary file may be converted into an 8-bit vector. In embodiments, the vector may be of 8-bit unsigned integers. More generally, in embodiments, the vector may map the binary representation of a file to integers between 0 and 255.

From block 720 process 700 may proceed to block 730, where the 8-bit vector may be converted into a multi-dimensional array, and then resized. In embodiments, the multi-dimensional array may be a 2D array, and may be resized to a size of 224×224, or 299×299, for example. In embodiments, blocks 710 through 730 may be performed by converter 110 depicted in FIG. 1b, for example.

From block 730 process 700 may proceed to block 740, where the resized multi-dimensional array may be used to train an ANN or retrain, at least partially, an ANN to extract malware features from the multi-dimensional array. In embodiments, the ANN to be either trained or partially retrained may have an input layer, an output layer, and a plurality of hidden layers between the input and output layers. In embodiments, block 740 of process 700 may be performed by training 120 depicted in FIG. 1b, for example. It is noted that blocks 710 through 740 may be repeated for several malware binaries, such as may comprise an entire training set. Thus, process 700 may proceed from block 740 to query block 745, where it may be determined if there are additional malware binaries to train the ANN on. If Yes at query block 745, than process 700 may return to block 710, and repeat the process flow of blocks 710 through 740. However, if the result of query block 745 is No, then process 700 may proceed to block 750, where the trained or retrained ANN (whether partially retrained or fully trained) may be validated using a validation set, which, in embodiments, may also be a set of known malware binaries, but different from the training set. At block 750, process 700 may terminate.

It is here noted that process 700 of FIG. 7 may be used to train either of the ANNs shown in the ensemble system 200, illustrated in FIG. 2. Thus, in the case of partially retrained high resolution ANN 223, only the last few layers of the ANN will be retrained using process 700. However, the low-resolution ANN 227, which may, in embodiments, be fully trained from scratch, or may, using process 700, be trained on a training set of malware binaries. If low-resolution ANN 227 is to be trained from scratch, then at block 740 process 700 may perform the “train” option of block 740. In embodiments, the low-resolution ANN 227 may be fully trained from scratch on a malware dataset, and its architecture newly defined. Or, in embodiments, alternatively, the low-resolution ANN 227 may be fully trained from scratch on a malware dataset, but the architecture of the ANN may be preserved from existing neural network architectures, such as, for example, a LeNet structure, a CIFAR-10 neural network structure, or, for example, multilayer perceptrons to allow training and testing on different sizes of lower resolution malware images. In still alternate embodiments, low-resolution ANN 227 may be partially retrained, and utilize transfer learning, as described above in the case of high resolution ANN 223.

FIGS. 8-15b provide a description of the interpretability feature that can be added to the model disclosed in the previous FIGURES.

Machine learning is increasingly important in computer network security applications. Because of the large amount of malware and benignware data generated on a regular basis, including on a daily basis, it is impractical to analyze the data with human security researchers. Rather, an automated or algorithmic way is more practical to effectively detect malicious software. However, as discussed above, if security researchers and practitioners do not trust the machine learning model and its predictions, then even with high classification accuracy or low false positive rates, the model may not be deployed. Trusting the model may require interpretability and explainability.

Existing methods for interpreting machine learning models are relatively limited. Many of them depend on both the mathematical aspects of the model and the data representation. The mathematical aspects of the model provide the innate capability of whether interpretation can be derived via the mathematical formula.

The data representation, and to some degree feature extraction, provides human interpretability. This means that a human practitioner can understand whether the model makes sense for interpretable features used for classification. If the model picks up on nonsense features or relies on nonsense features for good classification outcomes, then the human researcher may consider the model to be suspect, despite its good outcomes.

Existing models, including support vector machine, logistic regression, or random forest, do provide some feature interpretation by weighing coefficients on features and deducing feature importance. A security practitioner can use the absolute values of the coefficients to identify features that are heavily relied on during training and decision-making. However, these methods do not provide as high performance as the deep transfer learning method described in this specification. In deep-learning, most models are a black box. Because of the complexity of the deep layers, deep-learning explainability has had limited attention in the art. The present specification provides a scheme for interpretation and untrustworthiness of a DNN model. One embodiment specifically provides for trustworthiness of image-based malware classification.

Specifically, the present specification adds a trust component onto the deep transfer learning method described in the previous FIGURES. This DTL model provides image-based malware classification. The trust component employs the local interpretable model-agnostic explanation method, and attaches it to the DTL model for malware classification.

By way of illustration, an explanation is defined as a model in a class of interpretable models. The input of the “explanations” (models in this case) are binary-valued {0, 1} vectors to indicate the existence of the feature components. A loss function preserving the model complexity and local proximity may be minimized to ensure interpretability and local fidelity. The trust component provides explanations on individual predictions. It can also be considered as a framework to evaluate the model fully before deploying in the wild, and thus provides an overall trust score for the model.

The trust component described herein provides interpretability and trustworthiness for deep transfer learning for image-based malware classification. This trust component is available for both static and dynamic image-based malware classification. The trust score may be evaluated on both individual predictions made by the DTL model, and for the DTL model as a whole.

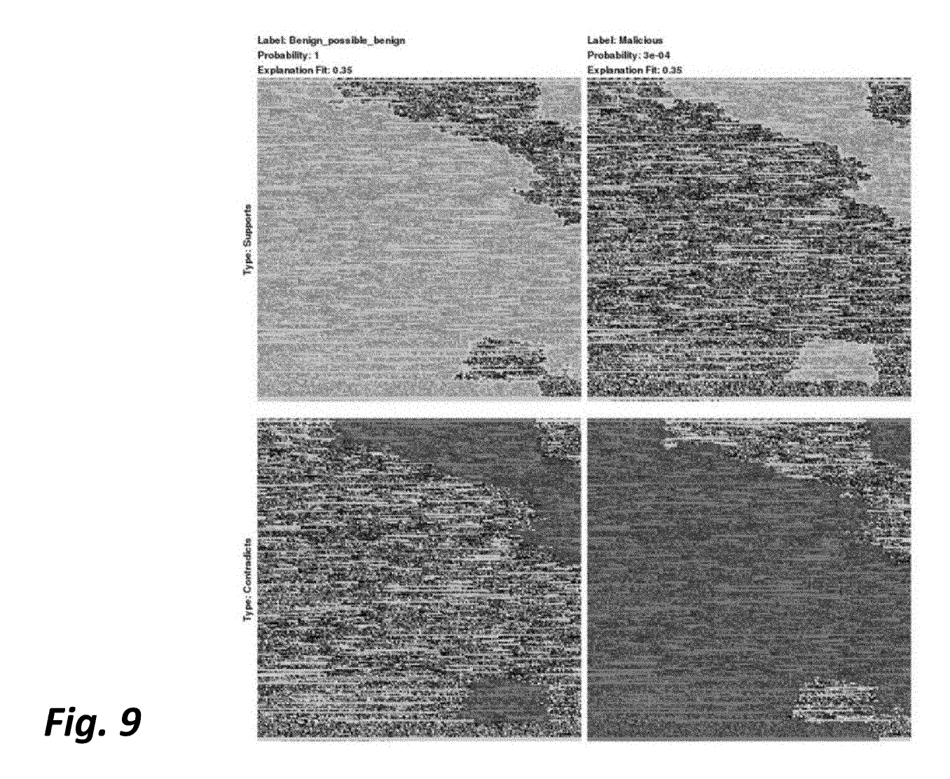

FIG. 8 illustrates a trust component analysis of a known malware object, while FIG. 9 illustrates a trust component analysis of a known benign object.

The examples of FIGS. 8 and 9 illustrate a two-class classification with 16,000 benign and 10,000 malicious samples. The goal is to classify each sample as either benign or malicious. In this example, VGG-16 was used for transfer learning, and the last three layers were trained with 32,000 parameters for training. The classification accuracy was over 99%.

For the malware classification, certain sequences may be identified as important features for malware determination. For example, a “top 10” list may be made of opcode n-grams that are important malicious features. These include:

TABLE 2
Top 10 Opcode N-gram

| Opcode N-gram | Feature Importance Ranking Score |
|---|---|
| pop-add-pop-rtn | 0.0051 |
| sub-lea-mov-push | 0.0048 |
| sub-lea-add-push | 0.0041 |
| ;-dd-;-align | 0.0036 |
| push-call-add-pop | 0.0036 |
| sub-lea-adc | 0.0034 |
| add-pop-rtn | 0.0031 |
| pop-call-add-pop | 0.0030 |
| cmp-jnz | 0.0030 |

As described in the previous FIGURES, each sample was vectorized and converted to a 2D array representing an image of the object. The DTL model then used computer vision to examine each image and determine which objects were malware and which objects were benign.

FIG. 8 illustrates a result of the trust component of the present specification. In this example, the DTL model determined whether the software, represented in greyscale image, was benign or malware. The four-panel figures illustrate the following: 1. Left (top and bottom): the prediction on the file as malicious by the deep transfer learning algorithm. 1.1. Top left: The green areas indicate the regions that support the prediction as malicious. 1.2. Bottom left: the red areas indicate the regions that do not support the prediction as malicious. 2. Right (top and bottom): the prediction on the file as benign by the deep transfer learning algorithm. 1.1. Top right: The green areas indicate the regions that support the prediction as benign. 1.2. Bottom right: the red areas indicate the regions that do not support the prediction as benign. In the visualization, the highest prediction probability and its corresponding class will be plotted on the left first. The least prediction probability, i.e., the least likely predicted class, will be plotted on the far right. As seen in this FIGURE, the model predicts with close to one probability that the file is malicious. On the left is what the algorithm determines as the most likely predicted class and what contributes or does not contribute to the prediction of the class. As seen in FIG. 8 left top and bottom figures, the predicted class with highest probability (close to one) is malicious class. The top left figure plots the regions in green that contribute to the proposition that the file is malicious, so that security researchers can look into these areas and identify (new) malware signatures. The bottom left figure plots the regions in red that contribute to indicate these regions contradict the prediction as malicious. As we can see, the red regions are much less compared with the green region. These regions could mean they are very similar to the structures for benign files.

On the right is the counter-proposition. The top and bottom figures on the right are the results of the model predicting the file as benign. The model determined a probability of 3.4×10⁻¹⁴ that the object is benign, which is one minus the probability of being malicious. In other words, the model is certain (probability 1) that the object is malicious, and functionally certain (probability near 0) that the object is not benign. Areas marked in green contribute to the proposition that the malware image is malicious. Areas marked in green indicate these areas are what the deep learning algorithm sees as benign regions such that it predicts the file as benign. Note that the areas marked in red in the lower left indicate where the deep learning algorithm sees as not contributing to the prediction of being benign.

An analysis of the assembly code was performed for the malicious sample, as presented in FIG. 8. It was found that several of the opcode n-grams occurred at the top location, in the text section of the assembly code. In particular, before line 5000 in the text section, the sequence “add-pop-rtn” occurred more than three times. Note that in the image representation, the image size is 224×224. So, the location is toward the beginning of the image.

An analysis was also done on a known benign software represented in its greyscale image representation. This is illustrated in FIG. 9. The trust component of the DTL model identified different regions of each image. In the visualization, the highest prediction probability and its corresponding class will be plotted on the left first. The least prediction probability, i.e., the least likely predicted class, will be plotted on the far right. The algorithm predicts with high confidence close to 1 that the file is benign. Hence the benign prediction results will be plotted on the left panels first. The malicious prediction results, with probability being 1 minus benign prediction, will be plotted to the right. The four-panel figures illustrate the following: 1. Left (top and bottom): the prediction on the file as benign by the deep transfer learning algorithm. 1.1. Top left: The green areas indicate the regions that support the prediction as benign. 1.2. Bottom left: the red areas indicate the regions that do not support the prediction as benign. 2. Right (top and bottom): the prediction on the file as malicious by the deep transfer learning algorithm. 1.1. Top right: The green areas indicate the regions that support the prediction as malicious. 1.2. Bottom right: the red areas indicate the regions that do not support the prediction as malicious. As would be expected for a benign file, the trust component marked large swaths of the file in green, as supporting to be benign and marked only small green areas on the right top plot to indicate the regions supporting as malicious. In other words, most of the areas in the benign image are considered benign, which is consistent with expectations for a benign object.

Note that the images presented here are only the text portion of the binary. The interpretability component suggests that the beginning of the text area is indicative of malicious characteristics. However the method is generalizable to consume all the contents in the binary.

As seen in the FIG. 8, for this malicious sample, the predicted prob as malicious is 1. The green areas indicate where the interpretability algorithm thinks it is contributing to the predicted label as malicious. Note that the images are only the text portion of the binary. The interpretability component suggests the beginning of the text area is indicative for malicious characteristics.

Inversely, when the DTL model analyzed the same image to determine whether it was benign, it determined that the probability that it was malicious was 3.4×10⁻¹⁴. In this case, areas marked in green are those which the DTL model sees as contributing to being classified as benign. In the image below, areas marked in red are substantially larger and they are what the DTL model sees as contributing to not being benign.

It can be seen that the textural and structural information represented as an image strongly suggests a pattern difference between benign and malicious software. The interpretability component further identifies the regions of interest for security experts to validate and identify important malicious patterns.

It should be noted that, while an initial naïve inspection may lead to the conjecture that every area of the image must be considered either benign or malicious, this is not in fact true. For example, a closer inspection will reveal that there is an area in the lower right corner of the image that contributed to neither the malware thesis or the benign thesis.

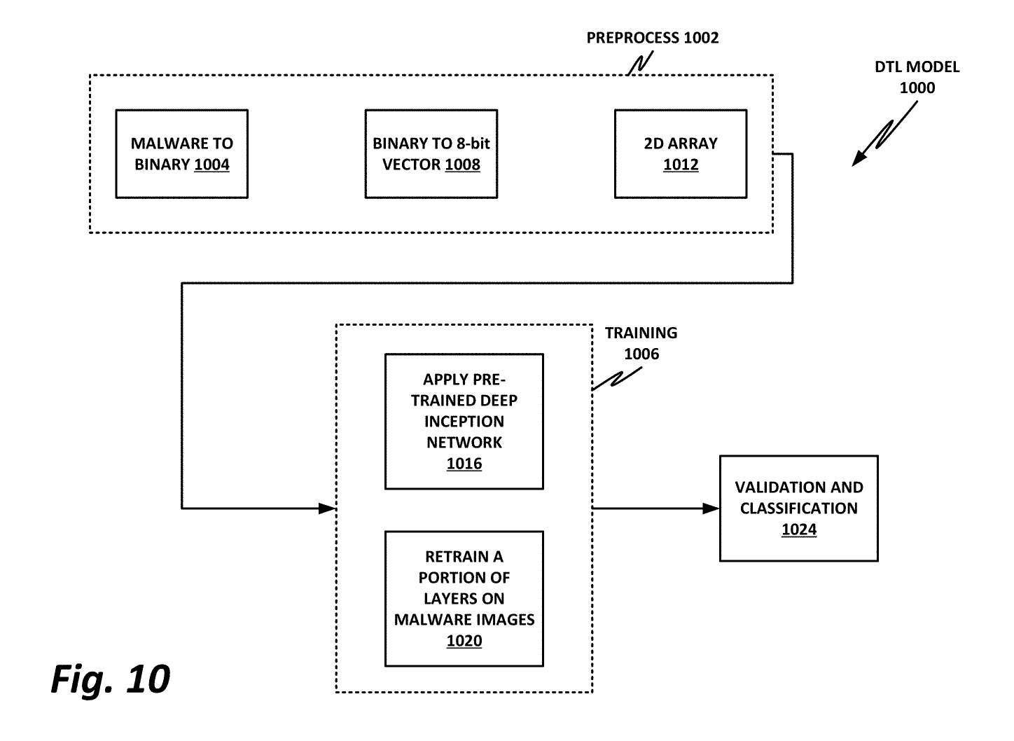

FIG. 10 is a block diagram of a deep transfer learning (DTL) model 1000. As discussed above, the DTL model 1000 as originally described provided for efficient malware classification. The application binary was directly mapped to integer values between 0 and 255, and then resized into 2D arrays. A pre-trained deep-learning neural network such as VGG, Inception, ResNet, or similar could be fine-tuned for the last few fully connected layers on the malware represented as images. This is called transfer learning. However, as originally described, DTL model 1000 did not include interpretability or trustworthiness features. Indeed, machine learning models in general are treated primarily as black boxes with little explainability or interpretability.

Despite the lack of explainability and interpretability, the machine learning model discussed herein achieved superior performance in recognizing malware images. The model had both very high accuracy and a very low false positive rate. This is illustrated in the table below, which provides machine learning comparison analysis of DTL for malware classification.

TABLE 3
Machine Learning Comparison

| Algorithm | Accuracy | FPR | TPR | Data shape |
|---|---|---|---|---|
| Disclosed Method | 99.25% | 0.30% | 98.15% | 224 × 224 × 3 |
| TFS via shallow | 97.14% | 0.120% | 91.78% | 224 × 224 × |
| NN º PCA | | | | 1 → 50176 → 100 |
| Naïve Bayesº | 88.05% | .501% | 88.84% | 224 × 224 × |
| PCA | | | | 1 → 50176 → 100 |
| 5-nearest neighborº | 97.90% | .087% | 94.79% | 224 × 224 × |
| PCA | | | | 1 → 50176 → 100 |
| LDA º PCA | 92.51% | .334% | 83.18% | 224 × 224 × |
| | | | | 1 → 50176 → 100 |
| Random forestº | 98.12% | .078% | 95.14% | 224 × 224 × |
| PCA | | | | 1 → 50176 → 100 |
| XGB º PCA | 98.44% | .065% | 95.97% | 224 × 224 × |
| | | | | 1 → 50176 → 100 |
| SVM-linearº PCA | 97.74% | .095% | 94.30% | 224 × 224 × |
| | | | | 1 → 50176 → 100 |
| SVM-radialº PCA | 95.69% | .179% | 90.02% | 224 × 224 × |
| | | | | 1 → 50176 → 100 |
| TFS via Small | 95.28% | .211% | 87.68% | 28 × 28 × 1 |
| Inception | | | | |
| TFS via shallow NN | 93.00% | .303% | 81.91% | 28 × 28 × 1 → |
| | | | | 784 |
| Naïve Bayes | 94.02% | .249% | 85.65% | 28 × 28 × 1 → |
| | | | | 784 |
| 5-nearest neighbor | 44.40% | 2.257% | 56.37% | 28 × 28 × 1 → |
| | | | | 784 |
| LDA º PCA | 91.07% | .384% | 78.71% | 28 × 28 × 1 → |
| | | | | 784 → 50 |
| Random forest | 95.53% | .199% | 85.71% | 28 × 28 × 1 → |
| | | | | 784 |
| XGB | 95.37% | .192% | 86.37% | 28 × 28 × 1 → |
| | | | | 784 |
| SVM-linear | 92.14% | .379% | 78.12% | 28 × 28 × 1 → |
| | | | | 784 |
| SVM-radial | 92.25% | .374% | 78.36% | 28 × 28 × 1 → |
| | | | | 784 |

As seen in the table, on a data set of approximately 10,000 malware samples from 25 malware classes, the DTL model of the present specification outperformed existing models. Experimentally, the DTL method disclosed herein was also found have better performance than classical machine learning algorithms such as support vector machine, random forest, and similar.

Despite the superior performance of the DTL model, for a security practitioner to confidently adopt the model and deploy it in the wild, it is beneficial for the practitioner to be able to trust the model's predictions and see that the model can generate intelligent interpretation.

In FIG. 10, DTL model 1000 includes a preprocess 1002. Preprocess 1002 includes a malware to binary block 1004. In block 1004, the malware object is first converted into a binary byte stream. In block 1008, the binary byte stream is converted into a vector of 8-bit integers between 0 and 255.

In block 1012, the vector is converted into a 2D array of a suitable size, such as 224×224.

This yields an image or “picture” of the potential malware object that can then be provided to training block 1006. Training block 1006 applies the pre-trained deep inception network 1016, and then re-trains a portion of layers on malware images in block 1020. Validation and classification block 1024 then validates the model and classifies the malware object as either malware or benignware. The result of this model is a highly accurate malware prediction with a very low false positive rate. However, as illustrated in FIG. 10, DTL model 1000 lacks interpretability.

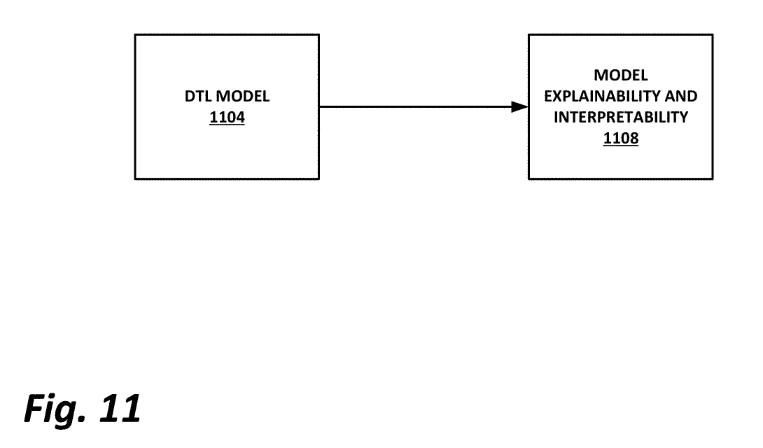

FIG. 11 is a block diagram of a model explainability and interpretability block 1108, as added to DTL model 1104. DTL model 1104 may be substantially similar or identical to DTL model 1000 of FIG. 10. Model explainability and interpretability block 1108 adds trust and faith to the DTL model for static malware classification.

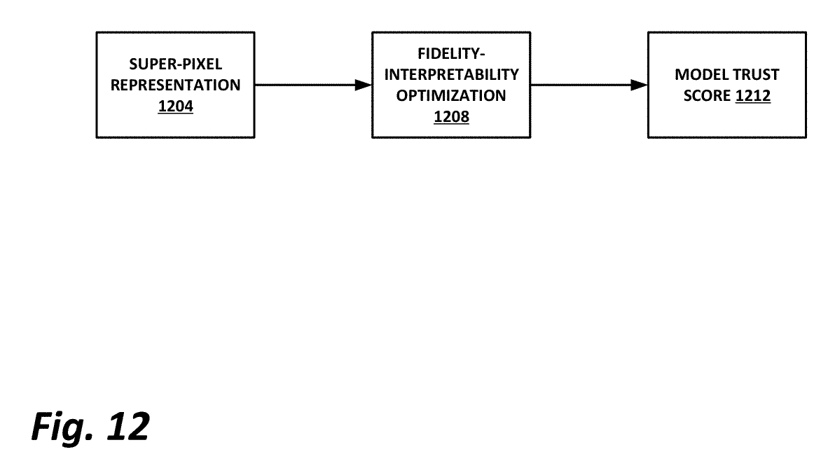

FIG. 12 is a block diagram of components in an explainability and interpretability block. As illustrated in FIG. 12, an explainability and interpretability block may include three components. Block 1204 is a super-pixel representation, block 1208 is a fidelity-interpretability optimization, and block 1212 is a model trust score.

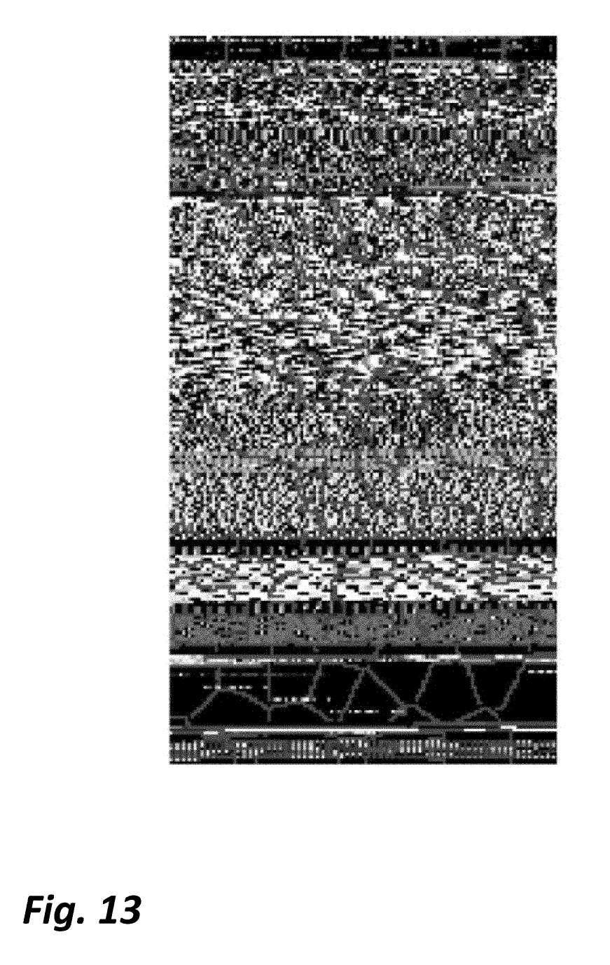

FIG. 13 illustrates a super-pixel representation. In FIG. 13, the image has been divided into super-pixels which are outlined in red.

A super-pixel is a region or patch of pixels adjacent to each other. As used herein, super-pixels are contiguous regions of pixels. An interpretable representation is a binary vector value {0, 1} to indicate the existence of the super-pixel region or patch.

For example, a malware image representation may be divided into 200 super-pixels. The interpretable explanation 2 is a vector in the set ∈{0, 1}²⁰⁰, which means 2 is a binary value with length 200, where 1 implies the super-pixel exists for interpretability, and 0 means the super-pixel is not used for interpretability.

A binary vector is associated with the super-pixels, indicating the existence or absence of the patch. A sparse linear function is trained on the sample, and close samples defined by proximity. The positivity or negativity of the weights provides interpretation of what the deep-learning model uses for classification.

Each super-pixel is an interpretable representation associated with a value of 0 or 1, denoting whether the absence or the presence of the patch is used for prediction. Using the kernel measure as a proximity of π(x, x′)=exp (−∥x−x′∥2/2/σ2), where x′ are sampled repeatedly 1000 times around the proximity of the sample x.

Sparse linear classifiers are trained on the collection of x and the associated 1000 close images. The weights are learned via least-squares with least absolute shrinkage and selection operator (LASSO)

$$constraints {min}_{{β}_{0} , β} \frac{1}{N} {\sum }_{i = 1} {( {y}_{i} - β 0 - {x}_{i}^{T} β )}^{2} subject to {‖ β ‖}_{1} \leq t .$$

This helps to visualize the explanation of why the DTL algorithm believes that the image belongs to a certain class of malware. For example, the image in FIG. 13 was classified by the DTL model as belonging to Lolyda.AA2 malware family with greater than 99% probability. As predicted, this sample is indeed a sample of a binary from Lolyda.AA2 malware family.

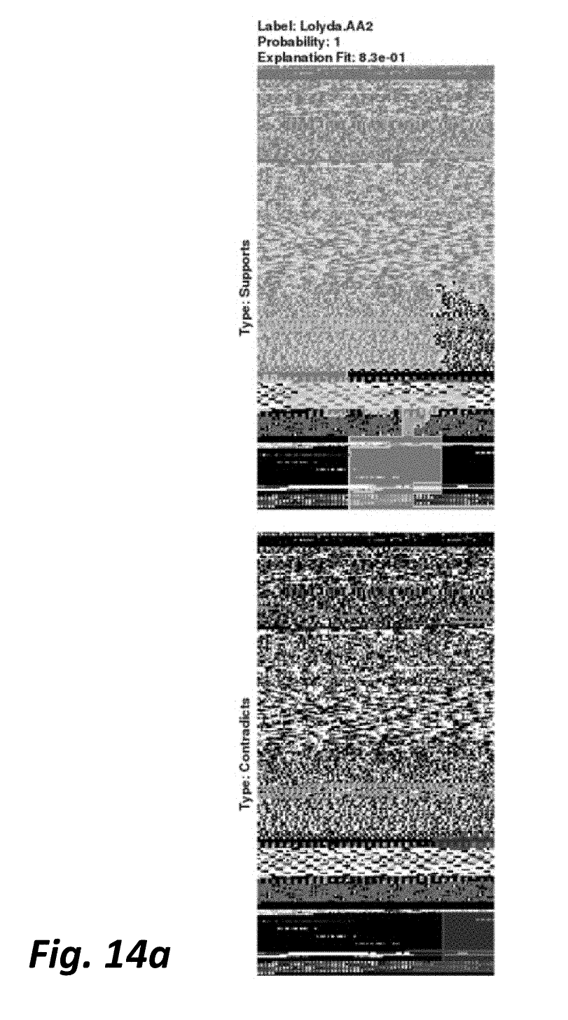

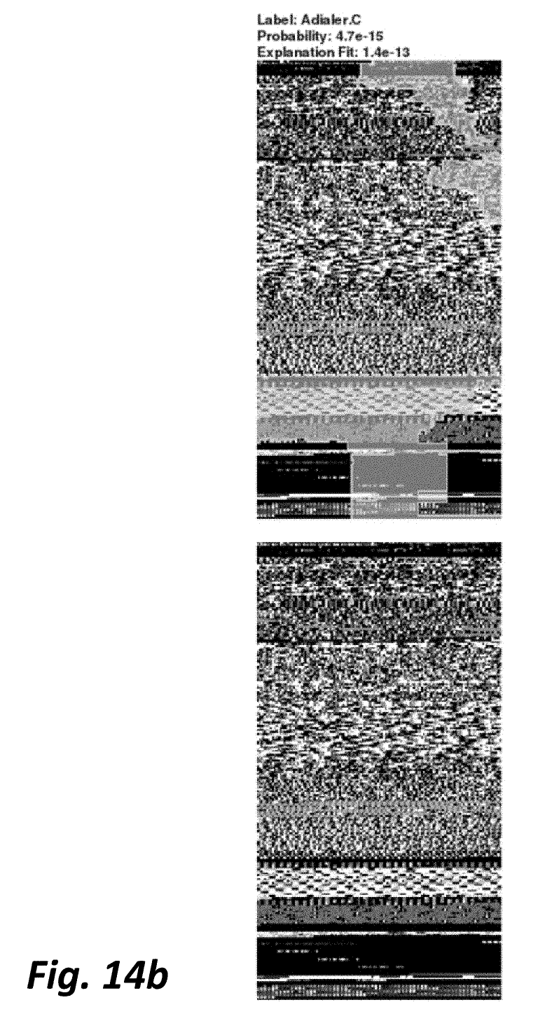

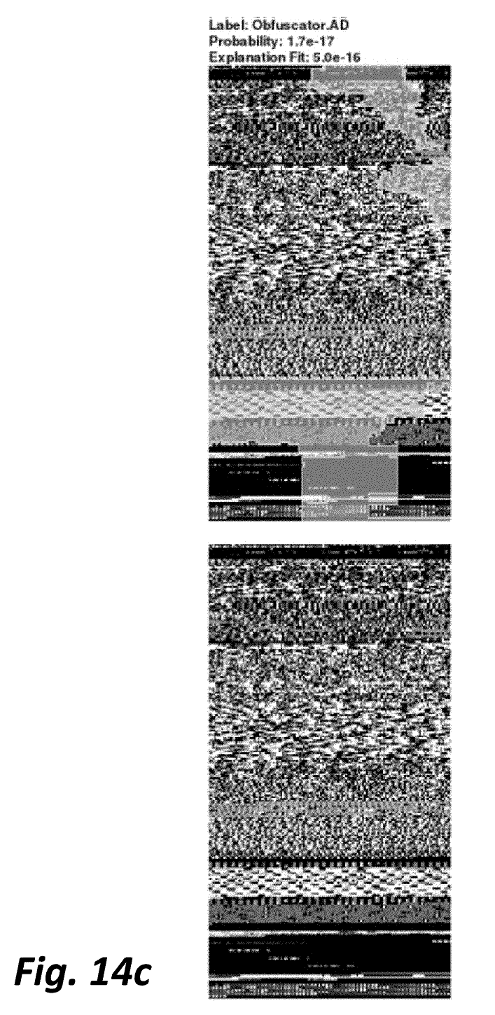

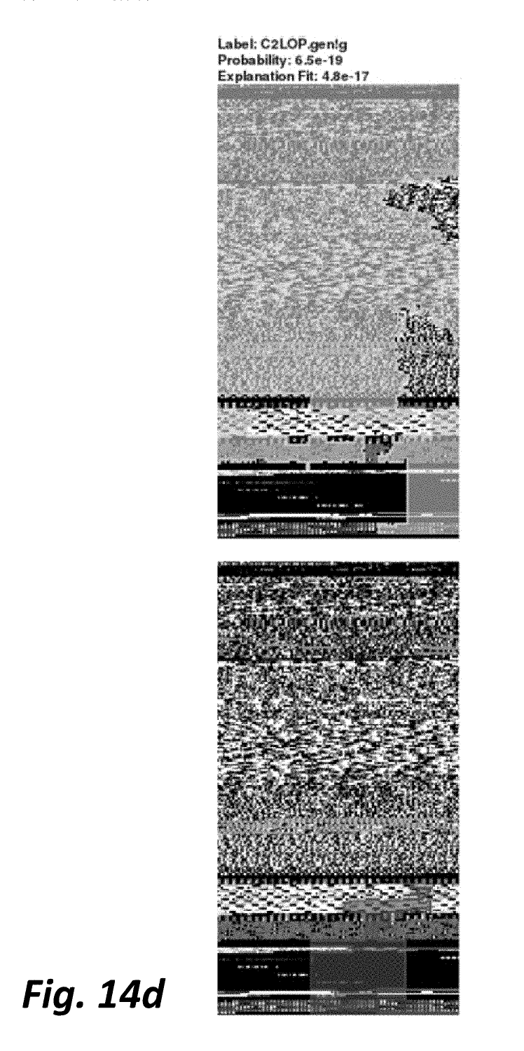

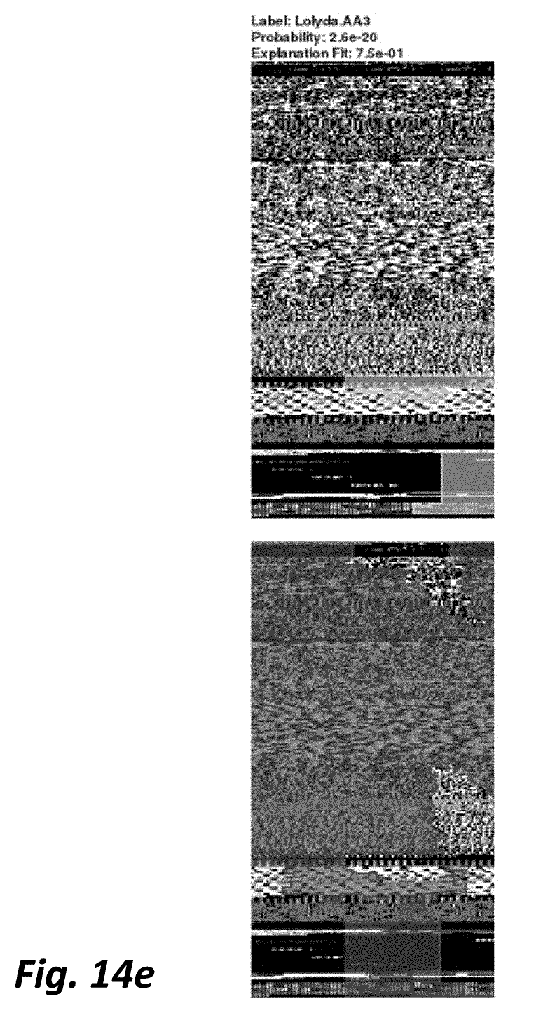

FIGS. 14a-14e plot the top five labels and explanations by the DTL model for a static malware classification. The positive weights toward each of the top five classes are highlighted in green patches, indicating that these super-pixel regions contribute to the DTL model's prediction that a specific class is present. The red regions are where the learned weights are negative and indicate that the DTL model does not find that these super-pixels contribute to a belief that the particular malware class is present. Given this explanation, a security practitioner can refer back to the malware binary or disassembled code, locate the particular locations of interest, and combine security domain expertise with deep-learning interpretation.

In FIG. 14a, the object is analyzed for membership in Lolyda.AA2. As seen by the large swaths of green, and the very small regions of red, there is a high probability that this object belongs to Lolyda.AA2. In fact, the model predicts with a probability of 1 that this is Lolyda.AA2, with an explanation fit of 0.83.

In FIG. 14b, the model is analyzed for membership in Adialer.C. In this case, there are relatively few regions of green, and the model predicts with a probability of 4.7×10⁻¹⁵ that the object belongs to Adialer.C. The explanation fit is 1.4×10⁻¹³. In this case, there are no red regions predicting that it does not belong to Adialer.C. In FIG. 14c, the object is analyzed for membership in Obfuscator.AD. The model predicts with a probability of 1.7×10⁻¹⁷ with an explanation fit of 5.0×10⁻¹⁶ that the object belongs to Obfuscator.AD. Again, there are no red regions matching to a negative prediction. In FIG. 14d, the model predicts with a probability of 6.5×10⁻¹⁹ that the object belongs to C2LOP.gen!g. The explanation fit is 4.8×10⁻¹⁷. There is a relatively small region of red for indicating a counter prediction. Finally, in FIG. 14e, the model predicts with a probability of 2.6×10⁻²⁰ that the object belongs to Lolyda.AA3. The explanation fit is 0.75. In this case, there are relatively few regions of green, and huge swaths of red in the image.

In sum, the model predicts with a very high probability that the object belongs to Lolyda.AA3, and predicts with very high probability that it does not belong to the other four classes of malware. This is consistent with the actual identity of the malware object, which is a malware object in the class Lolyda.AA3.

The second most likely class is Adialer.C, but the probability is a minuscule 4.7×10⁻¹⁵. If the goal is to understand what the deep-learning algorithm sees that differentiates samples from Adialer.C from samples in Lolyda.AA2, the images disclosed herein clearly illustrate which regions contribute to the prediction of Lolyda.AA2, and which contribute to the prediction of Adialer.C. As discussed above, a security researcher could validate the models by checking a decompiled source code for the appropriate opcode n-grams.

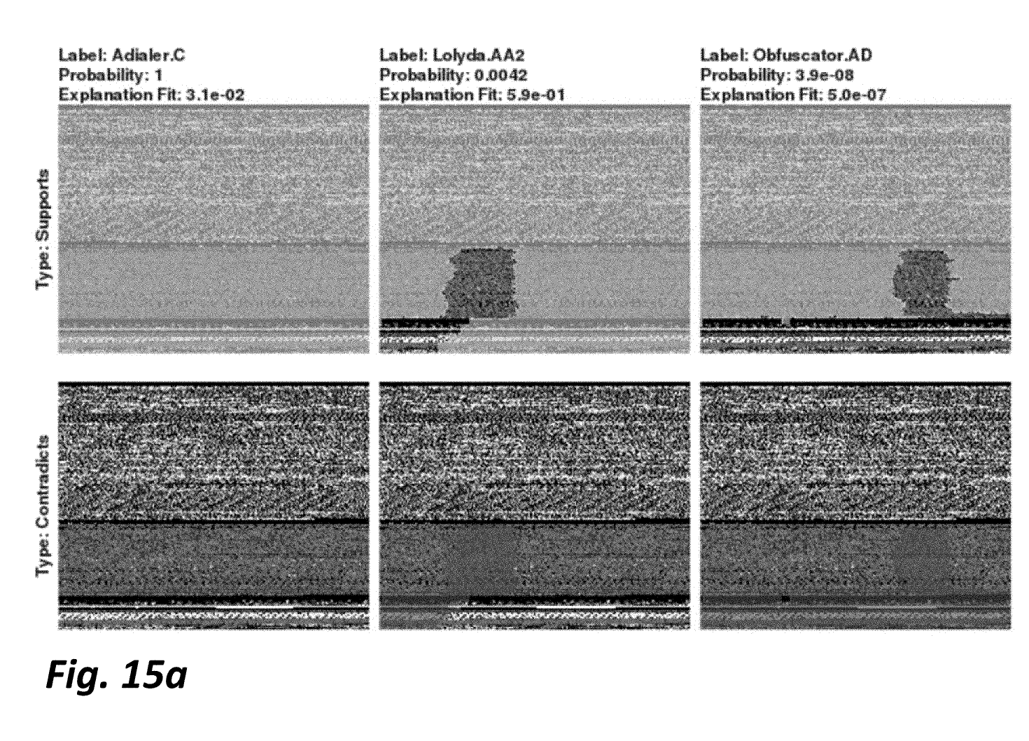

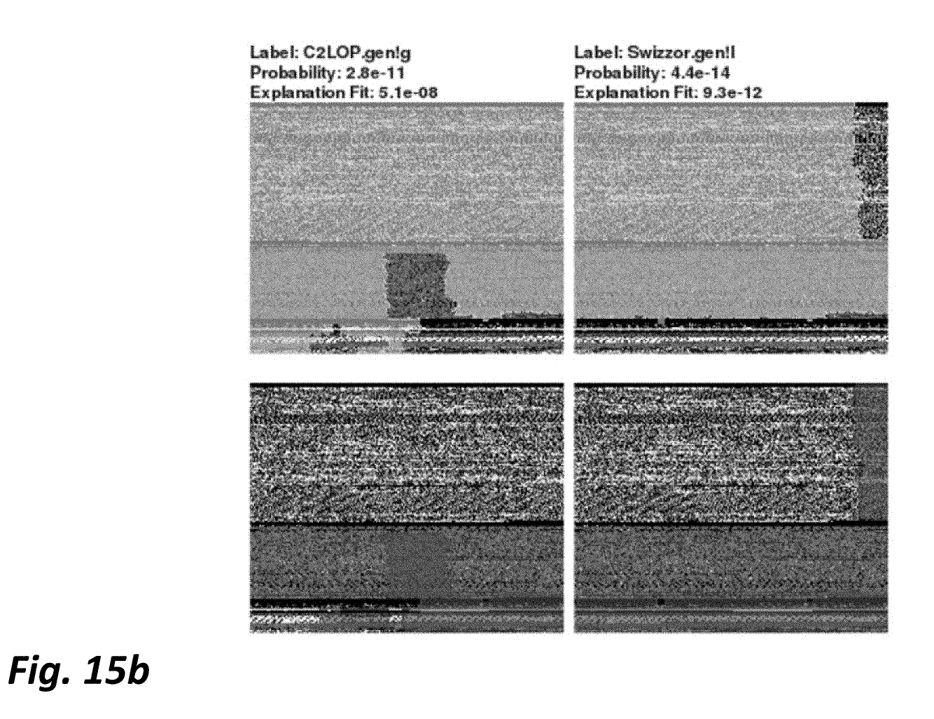

FIGS. 15a-15b illustrate a case where the model correctly predicts with greater than 99% probability that the object belongs to the class Adialer.C. The plots in FIGS. 15a and 15b illustrate which class the deep-learning algorithm sees within the malware image to make the classification. As seen in FIG. 15a, the model believes that Adialer.C is present everywhere in the malware image. The entire image is green, and no region is red. Thus, the model predicts with a probability of 1 that the object belongs to Adialer.C. The explanation fit is 3.1×10⁻².

When inspecting the object for membership in Lolyda.AA2, the model finds very large areas of green. Thus, the model determines with a probability of 0.0042 that the object belongs to Lolyda.AA2. However, there are also substantial red areas that indicate that the malware is not from Lolyda.AA2. A security practitioner could use this information to investigate the differences between the two malware families, both to enhance his or her knowledge of those malware families, as well as to validate the model.

For classes Obfuscator.AD, C2LOP.gen!g, and Swizzor.gen!l, there are substantial portions of green, and also substantial portions of red. Thus, the model predicts probabilities of 3.9×10⁻⁸, 2.8×10⁻¹¹, and 4.4×10⁻¹⁴ for these malware families, respectively. In other words, the model predicts correctly with a probability of 1 that the object belongs to Adialer.C. The next most probable family is Lolyda.AA2, but there is only a 0.42% probability of this prediction. In other words, the probability is still very low, and the red regions of this prediction are used to predict that this object does not belong to Lolyda.AA2. The other predictions have negligible probabilities.

Returning to FIG. 12, the super-pixel representation has been explained. However, to yield the full results as illustrated in FIGS. 14a through 15b, blocks 1208 and 1212 should also be explained in more detail. As illustrated in FIG. 12, block 1208 is fidelity-interpretability optimization. By way of example, a deep transfer learning approach for static malware classification can be denoted as function h. An explanation ƒ is an interpretable model applied on the interpretable representations \hat{x}, where \hat{x} is defined as above in relation to the super-pixel representation. The complexity of all explanations can be defined as Ω(ƒ). A goal is to minimize Ω(ƒ) as much as possible, so that it is interpretable to human practitioners.

A similarity measurement may be defined as π(x, x′), where x is the actual malware image and x′ is any similar or nearby malware images measured by the choice of distance. The loss function L(h, ƒ, π) can also be defined. This loss function measures how unfaithful ƒ is in explaining h, in the locality measured by the similarity π. Thus, this is a measure of local faithfulness. The overall objective function can then be minimized:

L(h,ƒ,π)+Ω(ƒ)=Σ_{x′x′}π(x,x′)(h(x)−ƒ(x′))²

The best explaining function ƒ* is the argmin of the above function:

ƒ*=arg min_{ƒ∈F}(L(h,ƒ,π)+Ω(ƒ))

A sparse linear explanation may be used to explain the deep transfer classifier for a static malware classifier. The steps include the following: first, define a similarity measure π(x, x′)=exp(−∥x−x′∥2/3/σ2), where x is a malware image and x′ is a similar image measured by it.

Select K features from the super-pixel representation and then use a K-lasso to train the sparse linear function on the binary-valued super-pixel representation. If the learned weights are positive on the super-pixel, this indicates that the model believes the super-pixel is important for predicting the sample as belonging to the class or label. If the learned weights are negative on the super-pixel, then the model does not think the class is present in the region. In FIGS. 14a through 15b, the green regions are the positive weights associated with the super-pixel, and the red regions are the negative weights associated with the super-pixel.

Model trust score 1212 can then be computed as follows. First, it is possible to evaluate the overall trustworthiness score for the deep transfer learning model for static malware classifications. The overall trust score may be an aggregation of the individual prediction's intelligent interpretation.

For example, in one case, a practitioner is willing to manually examine up to N predictions to ensure trust of the deep-learning malware classifier. N may be considered to be the cost for the practitioner to believe in or have trust in the model. The overall trust score is defined on the set of all samples X={x} and their proximity samples X′={x′} by a proximity measure π, such that when injecting nonsense features to the set, the trust score is the ratio of the number of unchanged predictions divided by N.

In other words, a nonsecure or untrustworthy feature may be injected into the data set. The nonsense feature can be NOPs (or 0s) on the malware images. Toward the end of the untrustworthy features are the lengths of the malware files. If the prediction outcomes from the classifier change when the nonsense features are injected, then the prediction of the model may not be deemed trustworthy. For a total of N predictions, all predictions ideally should remain unchanged despite adding in the nonsense features. This would yield a trust score of 100%. If all the predictions change when the model is trained on injecting nonsense features, then the trust score of the model is 0.

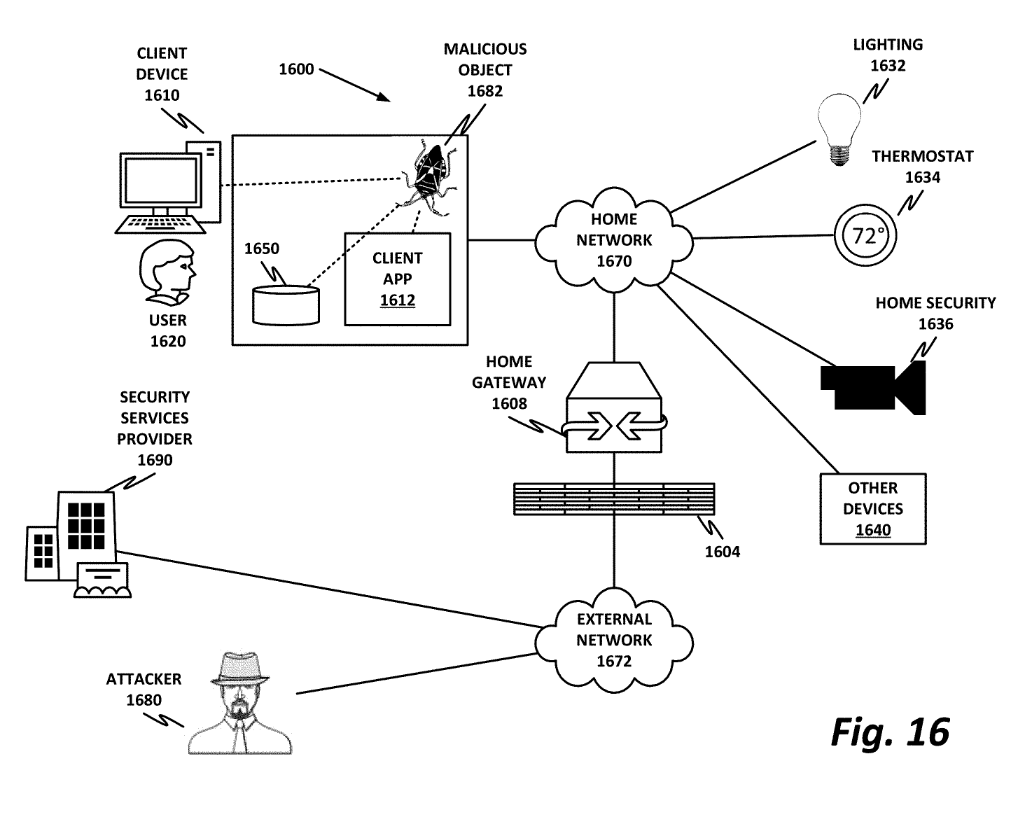

FIG. 16 is a block diagram of a home network 1600. Embodiments of home network 1600 disclosed herein may be adapted or configured to provide a trust model for binary classification, according to the teachings of the present specification. In the example of FIG. 16, home network 1600 may be a “smart home” with various Internet of things (IoT) devices that provide home automation or other services. Home network 1600 is provided herein as an illustrative and nonlimiting example of a system that may employ and benefit from the teachings of the present specification. But it should be noted that the teachings may also be applicable to many other entities including, by way of nonlimiting example, an enterprise, data center, telecommunications provider, government entity, or other organization.

Within home network 1600, one or more users 1620 operate one or more client devices 1610. A single user 1620 and single client device 1610 are illustrated here for simplicity, but a home or enterprise may have multiple users, each of which may have multiple devices.

Client devices 1610 may be communicatively coupled to one another and to other network resources via home network 1670. Home network 1670 may be any suitable network or combination of one or more networks operating on one or more suitable networking protocols, including a local area network, an intranet, a virtual network, a wide area network, a wireless network, a cellular network, or the Internet (optionally accessed via a proxy, virtual machine, or other similar security mechanism) by way of nonlimiting example. Home network 1670 may also include one or more servers, firewalls, routers, switches, security appliances, antivirus servers, or other network devices, which may be single-purpose appliances, virtual machines, containers, or functions running on client devices 1610.

In this illustration, home network 1670 is shown as a single network for simplicity, but in some embodiments, home network 1670 may include any number of networks, such as one or more intranets connected to the Internet. Home network 1670 may also provide access to an external network, such as the Internet, via external network 1672. External network 1672 may similarly be any suitable type of network.

Home network 1670 may connect to the Internet via a home gateway 1608, which may be responsible, among other things, for providing a logical boundary between home network 1672 and external network 1670. Home network 1670 may also provide services such as dynamic host configuration protocol (DHCP), gateway services, router services, and switching services, and may act as a security portal across home boundary 1604.

Home network 1600 may also include a number of discrete IoT devices, which in contemporary practice are increasing regularly. For example, home network 1600 may include IoT functionality to control lighting 1632, thermostats or other environmental controls 1634, a home security system 1636, and any number of other devices 1640. Other devices 1640 may include, as illustrative and nonlimiting examples, network-attached storage (NAS), computers, printers, smart televisions, smart refrigerators, smart vacuum cleaners and other appliances, and network connected vehicles.

Home network 1600 may communicate across home boundary 1604 with external network 1672. Home boundary 1604 may represent a physical, logical, or other boundary. External network 1672 may include, for example, websites, servers, network protocols, and other network-based services. In one example, an attacker 1680 (or other similar malicious or negligent actor) also connects to external network 1672. A security services provider 1690 may provide services to home network 1600, such as security software, security updates, network appliances, or similar.

It may be a goal of users 1620 and home network 1600 to successfully operate client devices 1610 and IoT devices without interference from attacker 1680 or from unwanted security objects. In one example, attacker 1680 is a malware author whose goal or purpose is to cause malicious harm or mischief, for example, by injecting malicious object 1682 into client device 1610. According to embodiments of the present specification, malicious object 1682 may include a fileless attack or a living off the land attack. Fileless attacks or living off the land attacks may be considered security threats or attacks, by way of nonlimiting example. Once malicious object 1682 gains access to client device 1610, it may try to perform work such as social engineering of user 1620, a hardware-based attack on client device 1610, modifying storage 1650 (or volatile memory), modifying client application 1612 (which may be running in memory), or gaining access to home resources. Furthermore, attacks may also be directed at IoT objects. IoT objects can introduce new security challenges, as they may be highly heterogeneous, and in some cases may be designed with minimal or no security considerations. To the extent that these devices have security, it may be added on as an afterthought. Thus, IoT devices may in some cases represent new attack vectors for attacker 1680 to leverage against home network 1670.

Malicious harm or mischief may take the form of installing root kits or other malware on client devices 1610 to tamper with the system, installing spyware or adware to collect personal and commercial data, defacing websites, operating a botnet such as a spam server, or simply to annoy and harass users 1620. Thus, one aim of attacker 1680 may be to install his malware on one or more client devices 1610 or any of the IoT devices described. As used throughout this specification, malicious software (“malware”) includes any security object configured to provide unwanted results or do unwanted work. In many cases, malware objects will be executable objects, including, by way of nonlimiting examples, viruses, Trojans, zombies, rootkits, backdoors, worms, spyware, adware, ransomware, dialers, payloads, malicious browser helper objects, tracking cookies, loggers, or similar objects designed to take a potentially-unwanted action, including, by way of nonlimiting example, data destruction, covert data collection, browser hijacking, network proxy or redirection, covert tracking, data logging, keylogging, excessive or deliberate barriers to removal, contact harvesting, and unauthorized self-propagation.

In enterprise cases, attacker 1680 may also want to commit industrial or other espionage, such as stealing classified or proprietary data, stealing identities, or gaining unauthorized access to enterprise resources. Thus, attacker 1680's strategy may also include trying to gain physical access to one or more client devices 1610 and operating them without authorization, so that an effective security policy may also include provisions for preventing such access.

In another example, a software developer may not explicitly have malicious intent, but may develop software that poses a security risk. For example, a well-known and often-exploited security flaw is the so-called buffer overrun, in which a malicious user is able to enter an overlong string into an input form and thus gain the ability to execute arbitrary instructions or operate with elevated privileges on a computing device. Buffer overruns may be the result, for example, of poor input validation or use of insecure libraries, and in many cases arise in nonobvious contexts. Thus, although not malicious, a developer contributing software to an application repository or programming an IoT device may inadvertently provide attack vectors for attacker 1680. Poorly-written applications may also cause inherent problems, such as crashes, data loss, or other undesirable behavior. Because such software may be desirable itself, it may be beneficial for developers to occasionally provide updates or patches that repair vulnerabilities as they become known. However, from a security perspective, these updates and patches are essentially new objects that must themselves be validated.

Home network 1600 may contract with or subscribe to a security services provider 1690, which may provide security services, updates, antivirus definitions, patches, products, and services. In some cases, security services provider 1690 may include a threat intelligence capability. Security services provider 1690 may update its threat intelligence database by analyzing new candidate malicious objects as they appear on client networks and characterizing them as malicious or benign.

Other considerations may include parents' desire to protect their children from undesirable content, such as pornography, adware, spyware, age-inappropriate content, advocacy for certain political, religious, or social movements, or forums for discussing illegal or dangerous activities, by way of nonlimiting example.

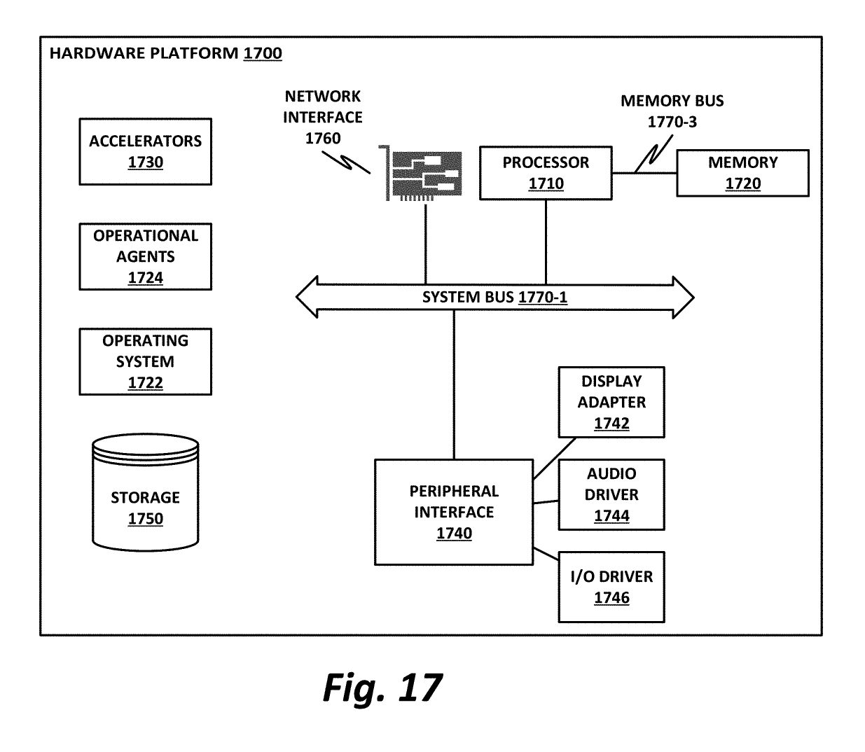

FIG. 17 is a block diagram of hardware platform 1700. Embodiments of hardware platform 1700 disclosed herein may be adapted or configured to provide a trust model for binary classification, according to the teachings of the present specification.

Hardware platform 1700 may represent any suitable computing device. In various embodiments, a “computing device” may be or comprise, by way of nonlimiting example, a computer, workstation, server, mainframe, virtual machine (whether emulated or on a “bare-metal” hypervisor), network appliance, container, IoT device, embedded computer, embedded controller, embedded sensor, personal digital assistant, laptop computer, cellular telephone, Internet protocol (IP) telephone, smart phone, tablet computer, convertible tablet computer, computing appliance, receiver, wearable computer, handheld calculator, or any other electronic, microelectronic, or microelectromechanical device for processing and communicating data. Any computing device may be designated as a host on the network. Each computing device may refer to itself as a “local host,” while any computing device external to it, including any device hosted on the same hardware but that is logically separated (e.g., a different virtual machine, container, or guest) may be designated as a “remote host.”

In certain embodiments, client devices 1610, home gateway 1608, and the IoT devices illustrated in FIG. 16 may all be examples of devices that run on a hardware platform such as hardware platform 1700. FIG. 17 presents a view of many possible elements that may be included in a hardware platform, but it should be understood that not all of these are necessary in every platform, and platforms may also include other elements. For example, peripheral interface 1740 may be an essential component in a user-class device to provide input and output, while it may be completely unnecessary in a virtualized server or hardware appliance that communicates strictly via networking protocols.

By way of illustrative example, hardware platform 1700 provides a processor 1710 connected to a memory 1720 and other system resources via one or more buses, such a system bus 1770-1 and a memory bus 1770-3.

Other components of hardware platform 1700 include a storage 1750, network interface 1760, and peripheral interface 1740. This architecture is provided by way of example only, and is intended to be nonexclusive and nonlimiting. Furthermore, the various parts disclosed are intended to be logical divisions only, and need not necessarily represent physically separate hardware and/or software components. Certain computing devices provide main memory 1720 and storage 1750, for example, in a single physical memory device, and in other cases, memory 1720 and/or storage 1750 are functionally distributed across many physical devices. In the case of virtual machines or hypervisors, all or part of a function may be provided in the form of software or firmware running over a virtualization layer to provide the disclosed logical function, and resources such as memory, storage, and accelerators may be disaggregated (i.e., located in different physical locations across a data center). In other examples, a device such as a network interface 1760 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

In various examples, a “processor” may include any combination of logic elements operable to execute instructions, whether loaded from memory, or implemented directly in hardware, including, by way of nonlimiting example, a microprocessor, digital signal processor, field-programmable gate array, graphics processing unit, programmable logic array, application-specific integrated circuit, or virtual machine processor. In certain architectures, a multi-core processor may be provided, in which case processor 1710 may be treated as only one core of a multi-core processor, or may be treated as the entire multi-core processor, as appropriate. In some embodiments, one or more co-processors may also be provided for specialized or support functions.

Processor 1710 may be communicatively coupled to devices via a system bus 1770-1. As used throughout this specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of nonlimiting example only, and that some embodiments may omit one or more of the foregoing buses, while others may employ additional or different buses. Common buses include peripheral component interconnect (PCI) and PCI express (PCIe), which are based on industry standards. However, system bus 1770-1 is not so limited, and may include any other type of bus. Furthermore, as interconnects evolve, the distinction between a system bus and the network fabric is sometimes blurred. For example, if a node is disaggregated, access to some resources may be provided over the fabric, which may be or include, by way of nonlimiting example, Intel® Omni-Path™ Architecture (OPA), TrueScale™, Ultra Path Interconnect (UPI) (formerly called QPI or KTI), FibreChannel, Ethernet, FibreChannel over Ethernet (FCoE), InfiniBand, PCI, PCIe, or fiber optics, to name just a few.

In an example, processor 1710 is communicatively coupled to memory 1720 via memory bus 1770-3, which may be, for example, a direct memory access (DMA) bus, though other memory architectures are possible, including ones in which memory 1720 communicates with processor 1710 via system bus 1770-1 or some other bus. In the same or an alternate embodiment, memory bus 1770-3 may include remote direct memory access (RDMA), wherein processor 1710 accesses disaggregated memory resources via DMA or DMA-like interfaces.

To simplify this disclosure, memory 1720 is disclosed as a single logical block, but in a physical embodiment may include one or more blocks of any suitable volatile or nonvolatile memory technology or technologies, including, for example, double data rate random-access memory (DDR RAM), static random-access memory (SRAM), dynamic random-access memory (DRAM), persistent random-access memory (PRAM), or other similar persistent fast memory, cache, Layer 1 (L1) or Layer 2 (L2) memory, on-chip memory, registers, flash, read-only memory (ROM), optical media, virtual memory regions, magnetic or tape memory, or similar. In certain embodiments, memory 1720 may comprise a relatively low-latency volatile main memory, while storage 1750 may comprise a relatively higher-latency nonvolatile memory. However, memory 1720 and storage 1750 need not be physically separate devices, and in some examples may represent simply a logical separation of function. It should also be noted that although DMA is disclosed by way of nonlimiting example, DMA is not the only protocol consistent with this specification, and that other memory architectures are available.

Storage 1750 may be any species of memory 1720, or may be a separate device. Storage 1750 may include one or more non-transitory computer-readable mediums, including, by way of nonlimiting example, a hard drive, solid-state drive, external storage, microcode, hardware instructions, redundant array of independent disks (RAID), NAS, optical storage, tape drive, backup system, cloud storage, or any combination of the foregoing. Storage 1750 may be, or may include therein, a database or databases or data stored in other configurations, and may include a stored copy of operational software such as operating system 1722 and software portions, if any, of operational agents 1724, accelerators 1730, or other engines. Many other configurations are also possible, and are intended to be encompassed within the broad scope of this specification.

As necessary, hardware platform 1700 may include an appropriate operating system, such as Microsoft Windows, Linux, Android, Mac OSX, Apple iOS, Unix, or similar. Some of the foregoing may be more often used on one type of device than another. For example, desktop computers or engineering workstations may be more likely to use one of Microsoft Windows, Linux, Unix, or Mac OSX. Laptop computers, which are usually a portable, off-the-shelf device with fewer customization options, may be more likely to run Microsoft Windows or Mac OSX. Mobile devices may be more likely to run Android or iOS. However, these examples are not intended to be limiting. Furthermore, hardware platform 1700 may be configured for virtualization or containerization, in which case it may also provide a hypervisor, virtualization platform, virtual machine manager (VMM), orchestrator, containerization platform, or other infrastructure to provide flexibility in allocating resources.

Network interface 1760 may be provided to communicatively couple hardware platform 1700 to a wired or wireless network or fabric. A “network,” as used throughout this specification, may include any communicative platform operable to exchange data or information within or between computing devices, including, by way of nonlimiting example, a local network, a switching fabric, an ad-hoc local network, an Internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

Operational agents 1724 are one or more computing engines that may include one or more non-transitory computer-readable mediums having stored thereon executable instructions operable to instruct a processor to provide operational functions. At an appropriate time, such as upon booting hardware platform 1700 or upon a command from operating system 1722 or a user or security administrator, processor 1710 may retrieve a copy of operational agents 1724 (or software portions thereof) from storage 1750 and load it into memory 1720. Processor 1710 may then iteratively execute the instructions of operational agents 1724 to provide the desired methods or functions.

As used throughout this specification, an “engine” includes any combination of one or more logic elements, of similar or dissimilar species, operable for and configured to perform one or more methods provided by the engine. In some cases, the engine may include a special integrated circuit designed to carry out a method or a part thereof, a field-programmable gate array (FPGA) programmed to provide a function, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware and software, including configuration files, registry entries, application programming interfaces (APIs), and interactive or user-mode software by way of nonlimiting example.

Peripheral interface 1740 may be configured to interface with any auxiliary device that connects to hardware platform 1700 but that is not necessarily a part of the core architecture of hardware platform 1700. A peripheral may be operable to provide extended functionality to hardware platform 1700, and may or may not be wholly dependent on hardware platform 1700. In some cases, a peripheral may be a computing device in its own right. Peripherals may include input and output devices such as displays, terminals, printers, keyboards, mice, modems, data ports (e.g., serial, parallel, universal serial bus (USB), Firewire, or similar), network controllers, optical media, external storage, sensors, transducers, actuators, controllers, data acquisition buses, cameras, microphones, speakers, or external storage, by way of nonlimiting example.

In one example, peripherals include display adapter 1742, audio driver 1744, and input/output (I/O) driver 1746. Display adapter 1742 may be configured to provide a human-readable visual output, such as a command-line interface (CLI) or graphical desktop such as Microsoft Windows, Apple OSX desktop, or a Unix/Linux X Window System-based desktop. Display adapter 1742 may provide output in any suitable format, such as a coaxial output, composite video, component video, video graphics array (VGA), or digital outputs such as digital visual interface (DVI) or high definition multimedia interface (HDMI), by way of nonlimiting example. In some examples, display adapter 1742 may include a hardware graphics card, which may have its own memory and its own graphics processing unit (GPU). Audio driver 1744 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth or Wi-Fi audio, by way of nonlimiting example.

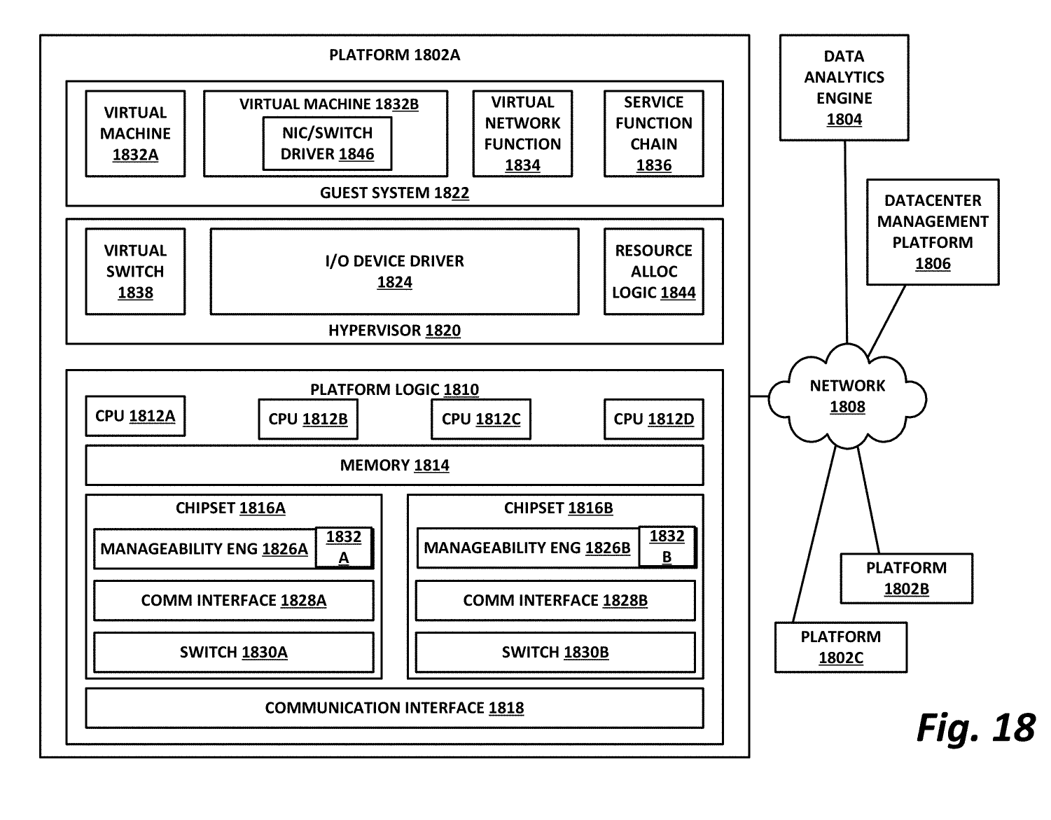

FIG. 18 is a block diagram of components of a computing platform 1802A. Embodiments of computing platform 1802A disclosed herein may be adapted or configured to provide a trust model for binary classification, according to the teachings of the present specification.

In the embodiment depicted, platforms 1802A, 1802B, and 1802C, along with a data center management platform 1806 and data analytics engine 1804 are interconnected via network 1808. In other embodiments, a computer system may include any suitable number (i.e., one or more) of platforms. In some embodiments (e.g., when a computer system only includes a single platform), all or a portion of the system management platform 1806 may be included on a platform 1802. A platform 1802 may include platform logic 1810 with one or more central processing units (CPUs) 1812, memories 1814 (which may include any number of different modules), chipsets 1816, communication interfaces 1818, and any other suitable hardware and/or software to execute a hypervisor 1820 or other operating system capable of executing workloads associated with applications running on platform 1802. In some embodiments, a platform 1802 may function as a host platform for one or more guest systems 1822 that invoke these applications. Platform 1802A may represent any suitable computing environment, such as a high performance computing environment, a data center, a communications service provider infrastructure (e.g., one or more portions of an Evolved Packet Core), an in-memory computing environment, a computing system of a vehicle (e.g., an automobile or airplane), an IoT environment, an industrial control system, other computing environment, or combination thereof.

In various embodiments of the present disclosure, accumulated stress and/or rates of stress accumulated of a plurality of hardware resources (e.g., cores and uncores) are monitored and entities (e.g., system management platform 1806, hypervisor 1820, or other operating system) of computer platform 1802A may assign hardware resources of platform logic 1810 to perform workloads in accordance with the stress information. In some embodiments, self-diagnostic capabilities may be combined with the stress monitoring to more accurately determine the health of the hardware resources. Each platform 1802 may include platform logic 1810. Platform logic 1810 comprises, among other logic enabling the functionality of platform 1802, one or more CPUs 1812, memory 1814, one or more chipsets 1816, and communication interfaces 1828. Although three platforms are illustrated, computer platform 1802A may be interconnected with any suitable number of platforms. In various embodiments, a platform 1802 may reside on a circuit board that is installed in a chassis, rack, or other suitable structure that comprises multiple platforms coupled together through network 1808 (which may comprise, e.g., a rack or backplane switch).

CPUs 1812 may each comprise any suitable number of processor cores and supporting logic (e.g., uncores). The cores may be coupled to each other, to memory 1814, to at least one chipset 1816, and/or to a communication interface 1818, through one or more controllers residing on CPU 1812 and/or chipset 1816. In particular embodiments, a CPU 1812 is embodied within a socket that is permanently or removably coupled to platform 1802A. Although four CPUs are shown, a platform 1802 may include any suitable number of CPUs.

Memory 1814 may comprise any form of volatile or nonvolatile memory including, without limitation, magnetic media (e.g., one or more tape drives), optical media, RAM, ROM, flash memory, removable media, or any other suitable local or remote memory component or components. Memory 1814 may be used for short, medium, and/or long term storage by platform 1802A. Memory 1814 may store any suitable data or information utilized by platform logic 1810, including software embedded in a computer-readable medium, and/or encoded logic incorporated in hardware or otherwise stored (e.g., firmware). Memory 1814 may store data that is used by cores of CPUs 1812. In some embodiments, memory 1814 may also comprise storage for instructions that may be executed by the cores of CPUs 1812 or other processing elements (e.g., logic resident on chipsets 1816) to provide functionality associated with the manageability engine 1826 or other components of platform logic 1810. A platform 1802 may also include one or more chipsets 1816 comprising any suitable logic to support the operation of the CPUs 1812. In various embodiments, chipset 1816 may reside on the same die or package as a CPU 1812 or on one or more different dies or packages. Each chipset may support any suitable number of CPUs 1812. A chipset 1816 may also include one or more controllers to couple other components of platform logic 1810 (e.g., communication interface 1818 or memory 1814) to one or more CPUs. In the embodiment depicted, each chipset 1816 also includes a manageability engine 1826. Manageability engine 1826 may include any suitable logic to support the operation of chipset 1816. In a particular embodiment, a manageability engine 1826 (which may also be referred to as an innovation engine) is capable of collecting real-time telemetry data from the chipset 1816, the CPU(s) 1812 and/or memory 1814 managed by the chipset 1816, other components of platform logic 1810, and/or various connections between components of platform logic 1810. In various embodiments, the telemetry data collected includes the stress information described herein.

In various embodiments, a manageability engine 1826 operates as an out-of-band asynchronous compute agent which is capable of interfacing with the various elements of platform logic 1810 to collect telemetry data with no or minimal disruption to running processes on CPUs 1812. For example, manageability engine 1826 may comprise a dedicated processing element (e.g., a processor, controller, or other logic) on chipset 1816, which provides the functionality of manageability engine 1826 (e.g., by executing software instructions), thus conserving processing cycles of CPUs 1812 for operations associated with the workloads performed by the platform logic 1810. Moreover, the dedicated logic for the manageability engine 1826 may operate asynchronously with respect to the CPUs 1812 and may gather at least some of the telemetry data without increasing the load on the CPUs.

A manageability engine 1826 may process telemetry data it collects (specific examples of the processing of stress information will be provided herein). In various embodiments, manageability engine 1826 reports the data it collects and/or the results of its processing to other elements in the computer system, such as one or more hypervisors 1820 or other operating systems and/or system management software (which may run on any suitable logic such as system management platform 1806). In particular embodiments, a critical event such as a core that has accumulated an excessive amount of stress may be reported prior to the normal interval for reporting telemetry data (e.g., a notification may be sent immediately upon detection).

Additionally, manageability engine 1826 may include programmable code configurable to set which CPU(s) 1812 a particular chipset 1816 will manage and/or which telemetry data will be collected.

Chipsets 1816 also each include a communication interface 1828. Communication interface 1828 may be used for the communication of signaling and/or data between chipset 1816 and one or more I/O devices, one or more networks 1808, and/or one or more devices coupled to network 1808 (e.g., system management platform 1806). For example, communication interface 1828 may be used to send and receive network traffic such as data packets. In a particular embodiment, a communication interface 1828 comprises one or more physical network interface controllers (NICs), also known as network interface cards or network adapters. A NIC may include electronic circuitry to communicate using any suitable physical layer and data link layer standard such as Ethernet (e.g., as defined by a IEEE 802.3 standard), Fibre Channel, InfiniBand, Wi-Fi, or other suitable standard. A NIC may include one or more physical ports that may couple to a cable (e.g., an Ethernet cable). A NIC may enable communication between any suitable element of chipset 1816 (e.g., manageability engine 1826 or switch 1830) and another device coupled to network 1808. In various embodiments a NIC may be integrated with the chipset (i.e., may be on the same integrated circuit or circuit board as the rest of the chipset logic) or may be on a different integrated circuit or circuit board that is electromechanically coupled to the chipset.

In particular embodiments, communication interfaces 1828 may allow communication of data (e.g., between the manageability engine 1826 and the data center management platform 1806) associated with management and monitoring functions performed by manageability engine 1826. In various embodiments, manageability engine 1826 may utilize elements (e.g., one or more NICs) of communication interfaces 1828 to report the telemetry data (e.g., to system management platform 1806) in order to reserve usage of NICs of communication interface 1818 for operations associated with workloads performed by platform logic 1810.

Switches 1830 may couple to various ports (e.g., provided by NICs) of communication interface 1828 and may switch data between these ports and various components of chipset 1816 (e.g., one or more Peripheral Component Interconnect Express (PCIe) lanes coupled to CPUs 1812). Switches 1830 may be a physical or virtual (i.e., software) switch.

Platform logic 1810 may include an additional communication interface 1818. Similar to communication interfaces 1828, communication interfaces 1818 may be used for the communication of signaling and/or data between platform logic 1810 and one or more networks 1808 and one or more devices coupled to the network 1808. For example, communication interface 1818 may be used to send and receive network traffic such as data packets. In a particular embodiment, communication interfaces 1818 comprise one or more physical NICs. These NICs may enable communication between any suitable element of platform logic 1810 (e.g., CPUs 1812 or memory 1814) and another device coupled to network 1808 (e.g., elements of other platforms or remote computing devices coupled to network 1808 through one or more networks).

Platform logic 1810 may receive and perform any suitable types of workloads. A workload may include any request to utilize one or more resources of platform logic 1810, such as one or more cores or associated logic. For example, a workload may comprise a request to instantiate a software component, such as an I/O device driver 1824 or guest system 1822; a request to process a network packet received from a virtual machine 1832 or device external to platform 1802A (such as a network node coupled to network 1808); a request to execute a process or thread associated with a guest system 1822, an application running on platform 1802A, a hypervisor 1820 or other operating system running on platform 1802A; or other suitable processing request.

A virtual machine 1832 may emulate a computer system with its own dedicated hardware. A virtual machine 1832 may run a guest operating system on top of the hypervisor 1820. The components of platform logic 1810 (e.g., CPUs 1812, memory 1814, chipset 1816, and communication interface 1818) may be virtualized such that it appears to the guest operating system that the virtual machine 1832 has its own dedicated components.

A virtual machine 1832 may include a virtualized NIC (vNIC), which is used by the virtual machine as its network interface. A vNIC may be assigned a media access control (MAC) address or other identifier, thus allowing multiple virtual machines 1832 to be individually addressable in a network.

VNF 1834 may comprise a software implementation of a functional building block with defined interfaces and behavior that can be deployed in a virtualized infrastructure. In particular embodiments, a VNF 1834 may include one or more virtual machines 1832 that collectively provide specific functionalities (e.g., WAN optimization, VPN termination, firewall operations, load-balancing operations, security functions, etc.). A VNF 1834 running on platform logic 1810 may provide the same functionality as traditional network components implemented through dedicated hardware. For example, a VNF 1834 may include components to perform any suitable NFV workloads, such as virtualized evolved packet core (vEPC) components, mobility management entities (MMEs), 3rd Generation Partnership Project (3GPP) control and data plane components, etc.

SFC 1836 is a group of VNFs 1834 organized as a chain to perform a series of operations, such as network packet processing operations. Service function chaining may provide the ability to define an ordered list of network services (e.g., firewalls and load balancers) that are stitched together in the network to create a service chain.

A hypervisor 1820 (also known as a virtual machine monitor) may comprise logic to create and run guest systems 1822. The hypervisor 1820 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 1810. Services of hypervisor 1820 may be provided by virtualizing in software or through hardware assisted resources that require minimal software intervention, or both. Multiple instances of a variety of guest operating systems may be managed by the hypervisor 1820. Each platform 1802 may have a separate instantiation of a hypervisor 1820.

Hypervisor 1820 may be a native or bare-metal hypervisor that runs directly on platform logic 1810 to control the platform logic and manage the guest operating systems. Alternatively, hypervisor 1820 may be a hosted hypervisor that runs on a host operating system and abstracts the guest operating systems from the host operating system. Hypervisor 1820 may include a virtual switch 1838 that may provide virtual switching and/or routing functions to virtual machines of guest systems 1822. The virtual switch 1838 may comprise a logical switching fabric that couples the vNICs of the virtual machines 1832 to each other, thus creating a virtual network through which virtual machines may communicate with each other.

Virtual switch 1838 may comprise a software element that is executed using components of platform logic 1810. In various embodiments, hypervisor 1820 may be in communication with any suitable entity (e.g., a SDN controller) which may cause hypervisor 1820 to reconfigure the parameters of virtual switch 1838 in response to changing conditions in platform 1802 (e.g., the addition or deletion of virtual machines 1832 or identification of optimizations that may be made to enhance performance of the platform).

Hypervisor 1820 may also include resource allocation logic 1844, which may include logic for determining allocation of platform resources based on the telemetry data (which may include stress information). Resource allocation logic 1844 may also include logic for communicating with various components of platform logic 1810 entities of platform 1802A to implement such optimization, such as components of platform logic 1810.

Any suitable logic may make one or more of these optimization decisions. For example, system management platform 1806; resource allocation logic 1844 of hypervisor 1820 or other operating system; or other logic of computer platform 1802A may be capable of making such decisions. In various embodiments, the system management platform 1806 may receive telemetry data from and manage workload placement across multiple platforms 1802. The system management platform 1806 may communicate with hypervisors 1820 (e.g., in an out-of-band manner) or other operating systems of the various platforms 1802 to implement workload placements directed by the system management platform.

The elements of platform logic 1810 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the computer platform 1802A may be coupled together in any suitable manner such as through one or more networks 1808. A network 1808 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices.

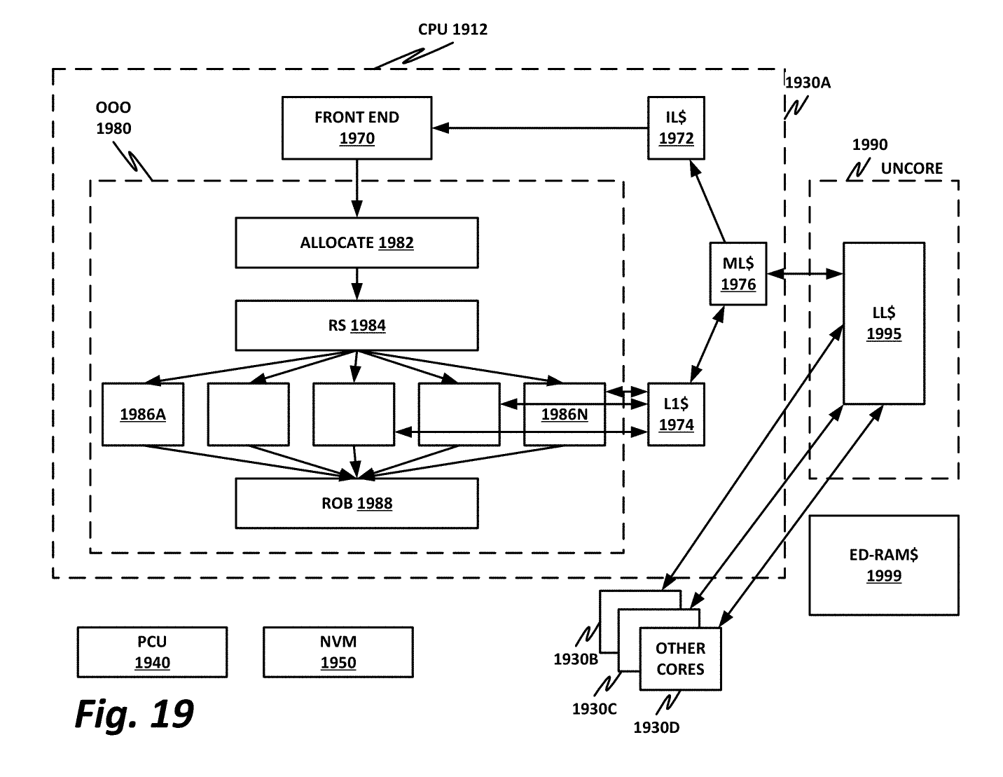

FIG. 19 illustrates a block diagram of a central processing unit (CPU) 1912. Embodiments of CPU 1912 disclosed herein may be adapted or configured to provide a trust model for binary classification, according to the teachings of the present specification.

Although CPU 1912 depicts a particular configuration, the cores and other components of CPU 1912 may be arranged in any suitable manner. CPU 1912 may comprise any processor or processing device, such as a microprocessor, an embedded processor, a digital signal processor (DSP), a network processor, an application processor, a co-processor, a system-on-a-chip (SoC), or other device to execute code. CPU 1912, in the depicted embodiment, includes four processing elements (cores 1930 in the depicted embodiment), which may include asymmetric processing elements or symmetric processing elements. However, C P U 1912 may include any number of processing elements that may be symmetric or asymmetric.

Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. A physical CPU may include any suitable number of cores. In various embodiments, cores may include one or more out-of-order processor cores or one or more in-order processor cores. However, cores may be individually selected from any type of core, such as a native core, a software managed core, a core adapted to execute a native instruction set architecture (ISA), a core adapted to execute a translated ISA, a co-designed core, or other known core. In a heterogeneous core environment (i.e. asymmetric cores), some form of translation, such as binary translation, may be utilized to schedule or execute code on one or both cores.

In the embodiment depicted, core 1930A includes an out-of-order processor that has a front end unit 1970 used to fetch incoming instructions, perform various processing (e.g., caching, decoding, branch predicting, etc.) and passing instructions/operations along to an out-of-order (OOO) engine. The OOO engine performs further processing on decoded instructions.

A front end 1970 may include a decode module coupled to fetch logic to decode fetched elements. Fetch logic, in one embodiment, includes individual sequencers associated with thread slots of cores 1930. Usually, a core 1930 is associated with a first ISA, which defines/specifies instructions executable on core 1930. Often, machine code instructions that are part of the first ISA include a portion of the instruction (referred to as an opcode), which references/specifies an instruction or operation to be performed. The decode module may include circuitry that recognizes these instructions from their opcodes and passes the decoded instructions on in the pipeline for processing as defined by the first ISA. Decoders of cores 1930, in one embodiment, recognize the same ISA (or a subset thereof). Alternatively, in a heterogeneous core environment, a decoder of one or more cores (e.g., core 1930B) may recognize a second ISA (either a subset of the first ISA or a distinct ISA).

In the embodiment depicted, the OOO engine includes an allocate unit 1982 to receive decoded instructions, which may be in the form of one or more micro-instructions or uops, from front end unit 1970, and allocate them to appropriate resources such as registers and so forth. Next, the instructions are provided to a reservation station 1984, which reserves resources and schedules them for execution on one of a plurality of execution units 1986A-1986N. Various types of execution units may be present, including, for example, arithmetic logic units (ALUs), load and store units, vector processing units (VPUs), and floating point execution units, among others. Results from these different execution units are provided to a reorder buffer (ROB) 1988, which take unordered results and return them to correct program order.

In the embodiment depicted, both front end unit 1970 and 000 engine 1980 are coupled to different levels of a memory hierarchy. Specifically shown is an instruction level cache 1972, that in turn couples to a mid-level cache 1976, that in turn couples to a last level cache 1995. In one embodiment, last level cache 1995 is implemented in an on-chip (sometimes referred to as uncore) unit 1990. Uncore 1990 may communicate with system memory 1999, which, in the illustrated embodiment, is implemented via embedded DRAM (eDRAM). The various execution units 1986 within OOO engine 1980 are in communication with a first level cache 1974 that also is in communication with mid-level cache 1976. Additional cores 1930B-1930D may couple to last level cache 1995 as well.

In particular embodiments, uncore 1990 may be in a voltage domain and/or a frequency domain that is separate from voltage domains and/or frequency domains of the cores. That is, uncore 1990 may be powered by a supply voltage that is different from the supply voltages used to power the cores and/or may operate at a frequency that is different from the operating frequencies of the cores.

CPU 1912 may also include a power control unit (PCU) 1940. In various embodiments, PCU 1940 may control the supply voltages and the operating frequencies applied to each of the cores (on a per-core basis) and to the uncore. PCU 1940 may also instruct a core or uncore to enter an idle state (where no voltage and clock are supplied) when not performing a workload.

In various embodiments, PCU 1940 may detect one or more stress characteristics of a hardware resource, such as the cores and the uncore. A stress characteristic may comprise an indication of an amount of stress that is being placed on the hardware resource. As examples, a stress characteristic may be a voltage or frequency applied to the hardware resource; a power level, current level, or voltage level sensed at the hardware resource; a temperature sensed at the hardware resource; or other suitable measurement. In various embodiments, multiple measurements (e.g., at different locations) of a particular stress characteristic may be performed when sensing the stress characteristic at a particular instance of time. In various embodiments, PCU 1940 may detect stress characteristics at any suitable interval.

In various embodiments, PCU 1940 is a component that is discrete from the cores 1930. In particular embodiments, PCU 1940 runs at a clock frequency that is different from the clock frequencies used by cores 1930. In some embodiments where the PCU is a microcontroller, PCU 1940 executes instructions according to an ISA that is different from an ISA used by cores 1930.

In various embodiments, CPU 1912 may also include a nonvolatile memory 1950 to store stress information (such as stress characteristics, incremental stress values, accumulated stress values, stress accumulation rates, or other stress information) associated with cores 1930 or uncore 1990, such that when power is lost, the stress information is maintained.

The foregoing outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in an SoC, including CPU package. An SoC represents an integrated circuit (IC) that integrates components of a computer or other electronic system into a single chip. Thus, for example, client devices 1610 or server devices may be provided, in whole or in part, in an SoC. The SoC may contain digital, analog, mixed-signal, and radio frequency functions, all of which may be provided on a single chip substrate. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

Note also that in certain embodiments, some of the components may be omitted or consolidated. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor, such as processor 1710, can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, an FPGA, an erasable programmable read-only memory (EPROM), an electrically erasable programmable read-only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage such as storage 1750 may store information in any suitable type of tangible, non-transitory storage medium (for example, RAM, ROM, FPGA, EPROM, electrically erasable programmable ROM (EEPROM), etc.), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, such as memory 1720 and storage 1750, should be construed as being encompassed within the broad terms ‘memory’ and ‘storage,’ as appropriate. A non-transitory storage medium herein is expressly intended to include any non-transitory, special-purpose or programmable hardware configured to provide the disclosed operations, or to cause a processor such as processor 1710 to perform the disclosed operations.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application-specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated or sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

### EXAMPLE IMPLEMENTATIONS

The following examples are provided by way of illustration.

Example 1 includes an apparatus, comprising: a hardware platform comprising a processor and a memory; an image classifier to operate on the hardware platform, the image classifier configured to classify an object under analysis as one of malware or benignware based on an image of the object; and a trust component configured to identify portions of the image that contribute to the classification.

Example 2 includes the apparatus of example 1, wherein the image classifier is further to assign the object as belonging to a class of malware.

Example 3 includes the apparatus of example 1, wherein the image classifier is to classify the object by converting the object to a binary vector, converting the binary vector to a multi-dimensional array, and analyzing the multi-dimensional array as an image.

Example 4 includes the apparatus of example 1, wherein the image classifier is an artificial neural network (ANN).

Example 5 includes the apparatus of example 4, wherein the ANN is a deep transfer learning ANN configured to receive a pre-trained model, freeze one or more layers of the pre-trained model, and retrain unfrozen layers on a problem-space relevant data set.

Example 6 includes the apparatus of example 5, wherein the ANN includes a deep-learning neural network selected from the group consisting of VGG, Inception, or ResNet.

Example 7 includes the apparatus of any of examples 1-6, wherein the trust component is to mark the portions of the image that contribute to the classification in a first color.

Example 8 includes the apparatus of example 7, wherein the trust component is further configured to identify portions of the image that negate the classification.

Example 9 includes the apparatus of example 8, wherein the trust component is further configured to mark portions of the image that negate the classification in a second color.

Example 10 includes the apparatus of example 7, wherein the trust component is configured to divide the image into a plurality of super-pixels, and to identify super-pixels that contribute to the classification.

Example 11 includes the apparatus of example 10, wherein the super-pixels correlate to one or more operation codes or instruction n-grams.

Example 12 includes the apparatus of example 10, wherein the trust component further comprises a solver to select K features of the super-pixels and to use a K-lasso to sparse linear functions on the super-pixels.

Example 13 includes the apparatus of example 7, wherein the trust component is configured to perform a fidelity-interpretability optimization.

Example 14 includes the apparatus of example 7, wherein the trust component is configured to compute a model trust score.

Example 15 includes one or more tangible, non-transitory computer-readable storage mediums having stored thereon executable instructions to: train a portion of a pre-trained deep-learning neural network to operate on computer objects; select an object under analysis; convert the object under analysis to an object image; operate the deep-learning neural network to classify the object as malicious or not malicious based on the object image; identify at least one portion of the object image that contributed to the classifying; and generate a modification of the object image with the at least one portion designated in a human-perceptible form.

Example 16 includes the one or more tangible, non-transitory computer-readable storage mediums of example 15, wherein the instructions are further to assign the object to a class of malware if the object is classified as malware.

Example 17 includes the one or more tangible, non-transitory computer-readable storage mediums of example 15, wherein training the portion of the pre-trained deep-learning neural network comprises freezing a plurality of lower levels of the pre-trained deep-learning neural network and retraining upper levels of the deep-learning neural network.

Example 18 includes the one or more tangible, non-transitory computer-readable storage mediums of example 17, wherein the deep-learning neural network is selected from the group consisting of VGG, Inception, or ResNet.

Example 19 includes the one or more tangible, non-transitory computer-readable storage mediums of example 15, wherein the instructions are further to mark the portions of the image that contribute to the classification in a first color.

Example 20 includes the one or more tangible, non-transitory computer-readable storage mediums of example 19, wherein the instructions are further to identify portions of the image that negate the classification.

Example 21 includes the one or more tangible, non-transitory computer-readable storage mediums of example 20, wherein the instructions are further to mark portions of the image that negate the classification in a second color.

Example 22 includes the one or more tangible, non-transitory computer-readable storage mediums of any of examples 15-21, wherein the instructions are further to divide the image into a plurality of super-pixels, and to identify super-pixels that contribute to the classification.

Example 23 includes the one or more tangible, non-transitory computer-readable storage mediums of example 22, wherein the super-pixels correlate to one or more operation code or instruction n-grams.

Example 24 includes the one or more tangible, non-transitory computer-readable storage mediums of example 22, wherein the instructions are further to select K features of the super-pixels and to use a K-lasso to sparse linear functions on the super-pixels.

Example 25 includes the one or more tangible, non-transitory computer-readable storage mediums of example 22, wherein the instructions are further to perform a fidelity-interpretability optimization.

Example 26 includes the one or more tangible, non-transitory computer-readable storage mediums of example 22, wherein the instructions are further to compute a model trust score.

Example 27 includes a computer-implemented method of performing a binary classification on an object under analysis, comprising: training a portion of a pre-trained deep-learning neural network to operate on computer objects; converting the object under analysis to an object image; operating the deep-learning neural network to perform a binary classification on the object based on the object image; identifying at least one portion of the object image that contributed to the classifying; and generating a modification of the object image with the at least one portion designated in a human-perceptible form.

Example 28 includes the method of claim 27 wherein the binary classification is a malware classification.

Example 29 includes the method of example 28, further comprising classifying as belonging to a malware class.

Example 30 includes the method of example 27, wherein training the portion of the pre-trained deep-learning neural network comprises freezing a plurality of lower levels of the pre-trained deep-learning neural network and retraining upper levels of the deep-learning neural network.

Example 31 includes the method of example 27, wherein the deep-learning neural network is selected from the group consisting of VGG, Inception, or ResNet.

Example 32 includes the method of example 27, further comprising marking the portions of the image that contribute to the classification in a first color.

Example 33 includes the method of example 32, further comprising identifying portions of the image that negate the classification.

Example 34 includes the method of example 33, further comprising marking portions of the image that negate the classification in a second color.

Example 35 includes the method of any of examples 27-34, further comprising dividing the image into a plurality of super-pixels, and to identify super-pixels that contribute to the classification.

Example 36 includes the method of example 35, wherein the super-pixels correlate to one or more operation codes or instruction n-grams.

Example 37 includes the method of example 35, further comprising selecting K features of the super-pixels and to use a K-lasso to sparse linear functions on the super-pixels.

Example 38 includes the method of example 35, further comprising performing a fidelity-interpretability optimization.

Example 39 includes the method of example 35, further comprising computing a model trust score.

What is claimed is:

1. An apparatus, comprising:
a hardware platform comprising a processor and a memory;
an image classifier to operate on the hardware platform, the image classifier configured to classify an object under analysis as one of malware or benignware based on an image of the object; and
a trust component configured to identify portions of the image that contribute to the classification.

2. The apparatus of claim 1, wherein the image classifier is further to assign the object as belonging to a class of malware.

3. The apparatus of claim 1, wherein the image classifier is to classify the object by converting the object to a binary vector, converting the binary vector to a multi-dimensional array, and analyzing the multi-dimensional array as an image.

4. The apparatus of claim 1, wherein the image classifier is an artificial neural network (ANN).

5. The apparatus of claim 4, wherein the ANN is a deep transfer learning ANN configured to receive a pre-trained model, freeze one or more layers of the pre-trained model, and retrain unfrozen layers on a problem-space relevant data set.

6. The apparatus of claim 5, wherein the ANN includes a deep-learning neural network selected from the group consisting of VGG, Inception, or ResNet.

7. The apparatus of claim 1, wherein the trust component is to mark the portions of the image that contribute to the classification in a first color.

8. The apparatus of claim 7, wherein the trust component is further configured to identify portions of the image that negate the classification.

9. The apparatus of claim 8, wherein the trust component is further configured to mark portions of the image that negate the classification in a second color.

10. The apparatus of claim 7, wherein the trust component is configured to divide the image into a plurality of super-pixels, and to identify super-pixels that contribute to the classification.

11. The apparatus of claim 10, wherein the super-pixels correlate to one or more operation codes or instruction n-grams.

12. The apparatus of claim 10, wherein the trust component further comprises a solver to select K features of the super-pixels and to use a K-lasso to sparse linear functions on the super-pixels.

13. The apparatus of claim 7, wherein the trust component is configured to perform a fidelity-interpretability optimization.

14. The apparatus of claim 7, wherein the trust component is configured to compute a model trust score.

15. One or more tangible, non-transitory computer-readable storage mediums having stored thereon executable instructions to:
train a portion of a pre-trained deep-learning neural network to operate on computer objects;
select an object under analysis;
convert the object under analysis to an object image;
operate the deep-learning neural network to classify the object as malicious or not malicious based on the object image;
identify at least one portion of the object image that contributed to the classifying; and
generate a modification of the object image with the at least one portion designated in a human-perceptible form.

16. The one or more tangible, non-transitory computer-readable storage mediums of claim 15, wherein the instructions are further to assign the object to a class of malware if the object is classified as malware.

17. The one or more tangible, non-transitory computer-readable storage mediums of claim 15, wherein training the portion of the pre-trained deep-learning neural network comprises freezing a plurality of lower levels of the pre-trained deep-learning neural network and retraining upper levels of the deep-learning neural network.

18. The one or more tangible, non-transitory computer-readable storage mediums of claim 15, wherein the instructions are further to mark the portions of the image that contribute to the classification of a most likely predicted class in a first color.

19. The one or more tangible, non-transitory computer-readable storage mediums of claim 18, wherein the instructions are further to identify portions of the image that contradict the classification of a most likely predicted class.

20. The one or more tangible, non-transitory computer-readable storage mediums of claim 19, wherein the instructions are further to mark portions of the image that negate the classification of a second most likely predicted class in a second color.

21. The one or more tangible, non-transitory computer-readable storage mediums of claim 15, wherein the instructions are further to divide the image into a plurality of super-pixels, and to identify super-pixels that contribute to the classification.

22. The one or more tangible, non-transitory computer-readable storage mediums of claim 15, wherein the instructions are further to divide the image into a plurality of super-pixels, and to identify super-pixels that contribute to the classification.

23. A computer-implemented method of performing a binary classification on an object under analysis, comprising:
training a portion of a pre-trained deep-learning neural network to operate on computer objects;
converting the object under analysis to an object image;
operating the deep-learning neural network to perform a binary classification on the object based on the object image;
identifying at least one portion of the object image that contributed to the classifying; and
generating a modification of the object image with the at least one portion designated in a human-perceptible form.

24. The method of claim 23 wherein the binary classification is a malware classification.

25. The method of claim 24, further comprising classifying as belonging to a malware class.
